(19) United States
(12) Patent Application Publication
(10) Pub. No.: US 2025/0172664 A1
(43) Pub. Date: May 29, 2025

(54) MEASUREMENT AND REPORTING FOR CHANNEL TARGET INDICATORS AND PATH TARGET INDICATORS FOR RADIO FREQUENCY SENSING

(71) Applicant: QUALCOMM Incorporated, San Diego, CA (US)

(72) Inventors: Marwen ZORGUI, San Diego, CA (US); Yun CHEN, Raleigh, NC (US); Srinivas YERRAMALLI, San Diego, CA (US); Rajat PRAKASH, San Diego, CA (US)

(21) Appl. No.: 18/520,750

(22) Filed: Nov. 28, 2023

(51) Int. Cl. G01S 7/41; G01S 7/00; G01S 13/56

(52) U.S. Cl. CPC G01S 7/414; G01S 7/006; G01S 7/417; G01S 13/56

(57) ABSTRACT

Disclosed are techniques for wireless communication. In an aspect, a first sensing node may obtain measurements of one or more paths of one or more first sensing reference signals associated with a second sensing node over a first wireless channel. The first sensing node may transmit, to a sensing entity, a first measurement report including a first channel target indicator (CTI) associated with the first wireless channel. In some cases, the first CTI indicates that the first wireless channel is estimated to include reflections from a target or that the first wireless channel is estimated to include clutter reflections absent target reflections.

### BACKGROUND OF THE DISCLOSURE

### 1. Field of the Disclosure

Aspects of the disclosure relate generally to wireless technologies.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)), and other technical enhancements. These enhancements, as well as the use of higher frequency bands, advances in PRS processes and technology, and high-density deployments for 5G, enable highly accurate 5G-based positioning.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a first sensing node includes obtaining measurements of one or more paths of one or more first sensing reference signals associated with a second sensing node over a first wireless channel; and transmitting, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

In some aspects, the method includes obtaining initial measurements of the one or more paths of the one or more first sensing reference signals during a first time period to obtain a reference state of the first wireless channel; and determining that the first wireless channel is estimated to include reflections from the target based at least in part on a comparison of a measured state and the reference state, wherein: the first CTI indicates that the first wireless channel is estimated to include reflections from the target based at least in part on the determining, and the measured state is based at least in part on the obtaining measurements of one or more paths of one or more first sensing reference signals associated with the second sensing node over the first wireless channel during a second time period different from the first time period.

In some aspects, the method includes estimating a Doppler profile for each of the one or more paths; and determining that the first wireless channel is estimated to include reflections from the target based at least in part on the estimating the Doppler profile for each of the one or more paths, wherein the first CTI indicates that the first wireless channel is estimated to include reflections from the target based at least in part on the determining.

In some aspects, the method includes determining that the target is estimated to be moving based at least in part on the estimating the Doppler profile for each of the one or more paths, wherein the first measurement report includes information indicating that the target is estimated to be moving.

In some aspects, the method includes receiving, from the sensing entity, a sensing configuration that includes first information and second information, wherein: the first information indicates that a first reference signal set including the one or more first sensing reference signals is associated with the second sensing node, and the second information indicates that a second reference signal set including one or more second sensing reference signals is associated with a third sensing node different from the second sensing node.

In some aspects, the method includes obtaining measurements of one or more paths of the one or more second sensing reference signals associated with the third sensing node over a second wireless channel different from the first wireless channel, wherein the first measurement report includes a second CTI associated with the second wireless channel.

In some aspects, the second CTI indicates that the second wireless channel is estimated to include reflections from the target or another target different from the target, or that the second wireless channel is estimated to include clutter reflections absent target reflections.

In some aspects, the method includes receiving, from the sensing entity, an indication of a neural network model for estimating the first CTI; obtaining the neural network model based at least in part on the received identification; and receiving assistance data associated with the neural network model.

In some aspects, the assistance data associated with the neural network model comprises information corresponding to a reference state of the first wireless channel.

In some aspects, the method includes obtaining measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target; and transmitting, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

In some aspects, the one or more second sensing reference signals are associated with a second frequency range different from a first frequency range of the one or more first sensing reference signals.

In some aspects, the method includes determining that at least one additional path is associated with the target based at least in part on the measurements of the one or more paths of the one or more first sensing reference signals, wherein the first measurement report includes information indicating the at least one additional path.

In some aspects, the method includes determining a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

In some aspects, the CTI is expressed as a hard value or a soft value.

In some aspects, the first sensing node is a user equipment (UE) or a transmission-reception point (TRP).

In some aspects, the first sensing node is a transmitting sensing node or a receiving sensing node.

In some aspects, the sensing entity is a sensing server or a next generation radio access network (NG-RAN) node.

In an aspect, a method of wireless communication performed by a first sensing node includes receiving, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and performing a sensing session over the wireless channel associated with the target based at least in part on at least one CTI of the one or more CTIs indicating that the wireless channel is estimated to include reflections from a target.

In some aspects, the method includes transmitting, to the sensing entity, a request for the one or more CTIs associated with the wireless channel, wherein the assistance data is received responsive to the request.

In some aspects, the information indicating one or more CTIs associated with the wireless channel comprises an information element corresponding to an expected likelihood of the target in a propagation path of the wireless channel from a transmission-reception point (TRP) to the first sensing node.

In some aspects, the method includes transmitting, to the sensing entity, a capability report of the first sensing node comprising an indication of support for CTIs, wherein the capability report of the first sensing node comprises an indicated type and granularity supported for the CTIs.

In some aspects, the method includes receiving, from the sensing entity, a request for a capability indication associated with the support for CTIs, wherein the capability report is transmitted responsive to the request.

In some aspects, the first sensing node is a user equipment (UE) and a transmitting sensing node.

In an aspect, a method of wireless communication performed by a first sensing node includes obtaining first measurements of one or more first paths of one or more sensing reference signals associated with a second sensing node over a wireless channel during a first time period; obtaining second measurements of one or more second paths of one or more sensing reference signals associated with a second sensing node over a wireless channel during a second time period different for the first time period; and transmitting, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

In some aspects, the method includes determining one or more additional paths for the wireless channel based at least in part on the obtaining the second measurements, wherein each PTI of the one or more PTIs corresponds to each additional path of the one or more additional paths.

In some aspects, each PTI of the one or more PTIs is indicated in a PTI field of an additional path information element, and the additional path information element includes a first field specifying a reference signal received path power and a second field specifying an angle of arrival for each additional path of the one or more additional paths.

In some aspects, the method includes transmitting, to the sensing entity, a capability report of the first sensing node comprising an indication of support for PTIs.

In some aspects, the method includes receiving, from the sensing entity, a request for a capability indication associated with the support for PTIs, wherein the capability report is transmitted responsive to the request.

In some aspects, each of the one or more PTIs is expressed as a hard value or a soft value.

In an aspect, a first sensing node includes one or more memories; one or more transceivers; and one or more processors communicatively coupled to the one or more memories and the one or more transceivers, the one or more processors, either alone or in combination, configured to: obtain measurements of one or more paths of one or more first sensing reference signals associated with a second sensing node over a first wireless channel; and transmit, via the one or more transceivers, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

In an aspect, a first sensing node includes one or more memories; one or more transceivers; and one or more processors communicatively coupled to the one or more memories and the one or more transceivers, the one or more processors, either alone or in combination, configured to: receive, via the one or more transceivers, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and perform a sensing session over the wireless channel associated with the target based at least in part on at least one CTI of the one or more CTIs indicating that the wireless channel is estimated to include reflections from a target.

In an aspect, a first sensing node includes one or more memories; one or more transceivers; and one or more processors communicatively coupled to the one or more memories and the one or more transceivers, the one or more processors, either alone or in combination, configured to: obtain first measurements of one or more first paths of one or more sensing reference signals associated with a second sensing node over a wireless channel during a first time period; obtain second measurements of one or more second paths of one or more sensing reference signals associated with a second sensing node over a wireless channel during a second time period different for the first time period; and transmit, via the one or more transceivers, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

In an aspect, a first sensing node includes means for obtaining measurements of one or more paths of one or more first sensing reference signals associated with a second sensing node over a first wireless channel; and means for transmitting, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

In an aspect, a first sensing node includes means for receiving, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and means for performing a sensing session over the wireless channel associated with the target based at least in part on at least one CTI of the one or more CTIs indicating that the wireless channel is estimated to include reflections from a target.

In an aspect, a first sensing node includes means for obtaining first measurements of one or more first paths of one or more sensing reference signals associated with a second sensing node over a wireless channel during a first time period; means for obtaining second measurements of one or more second paths of one or more sensing reference signals associated with a second sensing node over a wireless channel during a second time period different for the first time period; and means for transmitting, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

In an aspect, a non-transitory computer-readable medium stores computer-executable instructions that, when executed by a first sensing node, cause the first sensing node to: obtain measurements of one or more paths of one or more first sensing reference signals associated with a second sensing node over a first wireless channel; and transmit, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

In an aspect, a non-transitory computer-readable medium stores computer-executable instructions that, when executed by a first sensing node, cause the first sensing node to: receive, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and perform a sensing session over the wireless channel associated with the target based at least in part on at least one CTI of the one or more CTIs indicating that the wireless channel is estimated to include reflections from a target.

In an aspect, a non-transitory computer-readable medium stores computer-executable instructions that, when executed by a first sensing node, cause the first sensing node to: obtain first measurements of one or more first paths of one or more sensing reference signals associated with a second sensing node over a wireless channel during a first time period; obtain second measurements of one or more second paths of one or more sensing reference signals associated with a second sensing node over a wireless channel during a second time period different for the first time period; and transmit, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A, 2B, and 2C illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates examples of various positioning methods supported in New Radio (NR), according to aspects of the disclosure.

FIG. 5 illustrates an example Long-Term Evolution (LTE) positioning protocol (LPP) capability transfer procedure, assistance data transfer procedure, and location information transfer procedure between a target device and a location server, according to aspects of the disclosure.

FIGS. 6A and 6B illustrate different types of radar, according to aspects of the disclosure.

FIG. 7 illustrates an example call flow for an NR-based sensing procedure in which the network configures the sensing parameters, according to aspects of the disclosure.

FIGS. 8A-8E illustrate examples of line of sight (LOS)-non-line of sight (NLOS) indicator information elements, according to aspects of the disclosure.

FIG. 9 illustrates an example of an LOS-NLOS assistance data information element, according to aspects of the disclosure.

FIG. 10 illustrates a first example wireless communications system that supports measurement and reporting techniques for channel target indicators (CTIs) and path target indicators (PTIs) for sensing operations, according to aspects of the disclosure.

FIG. 11 illustrates a second example wireless communications system that supports measurement and reporting techniques for CTIs and PTIs for sensing operations, according to aspects of the disclosure.

FIG. 12 illustrates an example of an additional path indicator information element, according to aspects of the disclosure.

FIGS. 13 to 15 illustrate example processes of wireless communication, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

Various aspects relate generally to techniques for measurement and reporting of channel target indicators (CTIs) and path target indicators (PTIs) for sensing operations. In some examples, a first sensing node may obtain measurements of one or more paths of one or more sensing reference signals associated with a second sensing node over a wireless channel. For example, when the first sensing node is a receiving sensing node, the first sensing node may obtain the measurement from measurements performed by the first sensing node. When the first sensing node is a transmitting sensing node, the first sensing node may obtain measurements from the second sensing node configured as a corresponding receiving sensing node. The second sensing node may send the measurements to the first sensing node. The first sensing node may transmit, to a sensing entity, a measurement report including a CTI associated with the wireless channel. In some cases, the CTI indicates that the wireless channel is estimated to include reflections from a target or that the wireless channel is estimated to include clutter reflections absent target reflection.

In some examples, a first sensing node may obtain first measurements of one or more first paths of one or more sensing reference signals associated with a second sensing node over a wireless channel during a first time period. The first sensing node may also obtain second measurements of one or more second paths of one or more sensing reference signals associated with a second sensing node over a wireless channel during a second time period different for the first time period. The first sensing node may transmit, to a sensing entity, a measurement report including one or more PTIs associated with one or more second paths of the wireless channel. In some cases, each PTI of the one or more PTIs indicates that a corresponding second path of the one or more second paths is estimated to include reflections from a target or that the corresponding second path is estimated to include clutter reflections absent target reflections.

Particular aspects of the subject matter described in this disclosure can be implemented to realize one or more of the following potential advantages. In some examples, by indicating a CTI or a PTI, the sensing server can obtain location information of a target to efficiently detect and track the target in a wireless communications network.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE) and “base station” are not intended to be specific or otherwise limited to any particular radio access technology (RAT), unless otherwise noted. In general, a UE may be any wireless communication device (e.g., a mobile phone, router, tablet computer, laptop computer, consumer asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT.” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on the Institute of Electrical and Electronics Engineers (IEEE) 802.11 specification, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an uplink/reverse or downlink/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

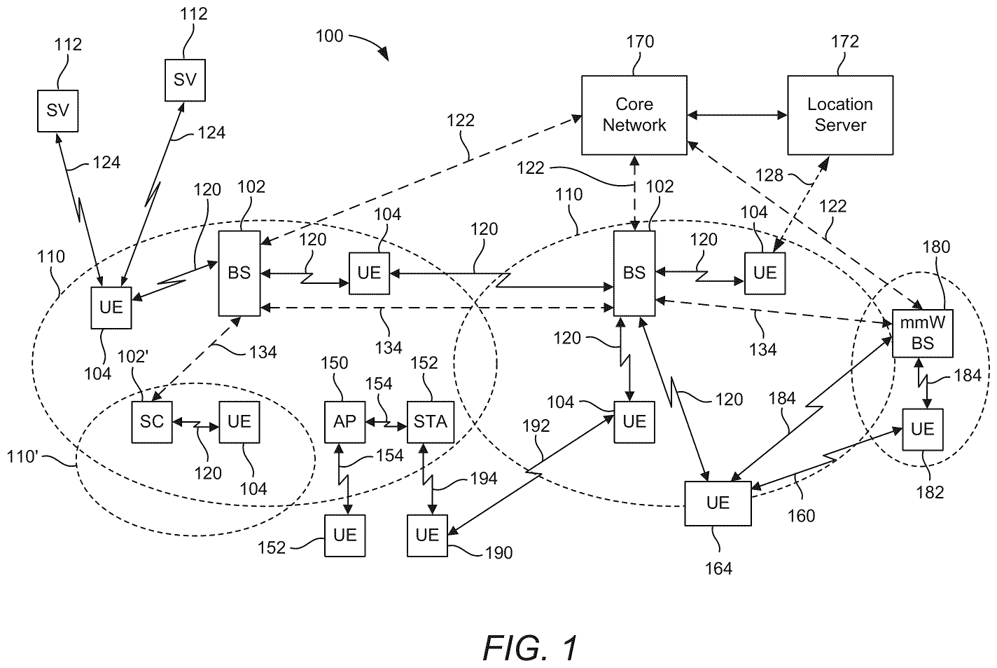

FIG. 1 illustrates an example wireless communications system 100, according to aspects of the disclosure. The wireless communications system 100 (which may also be referred to as a wireless wide area network (WWAN)) may include various base stations 102 (labeled “BS”) and various UEs 104. The base stations 102 may include macro cell base stations (high power cellular base stations) and/or small cell base stations (low power cellular base stations). In an aspect, the macro cell base stations may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labeled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHZ). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MULTEFIRE®.

The wireless communications system 100 may further include a millimeter wave (mmW) base station 180 that may operate in mmW frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHz and 30 GHZ, also referred to as centimeter wave. Communications using the mmW/near mmW RF band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHZ-7.125 GHZ) and FR2 (24.25 GHz-52.6 GHZ). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHZ-300 GHZ) which is identified by the INTERNATIONAL TELECOMMUNICATION UNION® as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHZ, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

The wireless communications system 100 may further include a UE 164 that may communicate with a macro cell base station 102 over a communication link 120 and/or the mmW base station 180 over a mmW communication link 184. For example, the macro cell base station 102 may support a PCell and one or more SCells for the UE 164 and the mmW base station 180 may support one or more SCells for the UE 164.

In some cases, the UE 164 and the UE 182 may be capable of sidelink communication. Sidelink-capable UEs (SL-UEs) may communicate with base stations 102 over communication links 120 using the Uu interface (i.e., the air interface between a UE and a base station). SL-UEs (e.g., UE 164, UE 182) may also communicate directly with each other over a wireless sidelink 160 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, vehicle-to-vehicle (V2V) communication, vehicle-to-everything (V2X) communication (e.g., cellular V2X (cV2X) communication, enhanced V2X (eV2X) communication, etc.), emergency rescue applications, etc. One or more of a group of SL-UEs utilizing sidelink communications may be within the geographic coverage area 110 of a base station 102. Other SL-UEs in such a group may be outside the geographic coverage area 110 of a base station 102 or be otherwise unable to receive transmissions from a base station 102. In some cases, groups of SL-UEs communicating via sidelink communications may utilize a one-to-many (1:M) system in which each SL-UE transmits to every other SL-UE in the group. In some cases, a base station 102 facilitates the scheduling of resources for sidelink communications. In other cases, sidelink communications are carried out between SL-UEs without the involvement of a base station 102.

In an aspect, the sidelink 160 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs. In an aspect, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Note that although FIG. 1 only illustrates two of the UEs as SL-UEs (i.e., UEs 164 and 182), any of the illustrated UEs may be SL-UEs. Further, although only UE 182 was described as being capable of beamforming, any of the illustrated UEs, including UE 164, may be capable of beamforming. Where SL-UEs are capable of beamforming, they may beamform towards each other (i.e., towards other SL-UEs), towards other UEs (e.g., UEs 104), towards base stations (e.g., base stations 102, 180, small cell 102′, access point 150), etc. Thus, in some cases, UEs 164 and 182 may utilize beamforming over sidelink 160.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1. UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WI-FI DIRECT®, BLUETOOTH®, and so on.

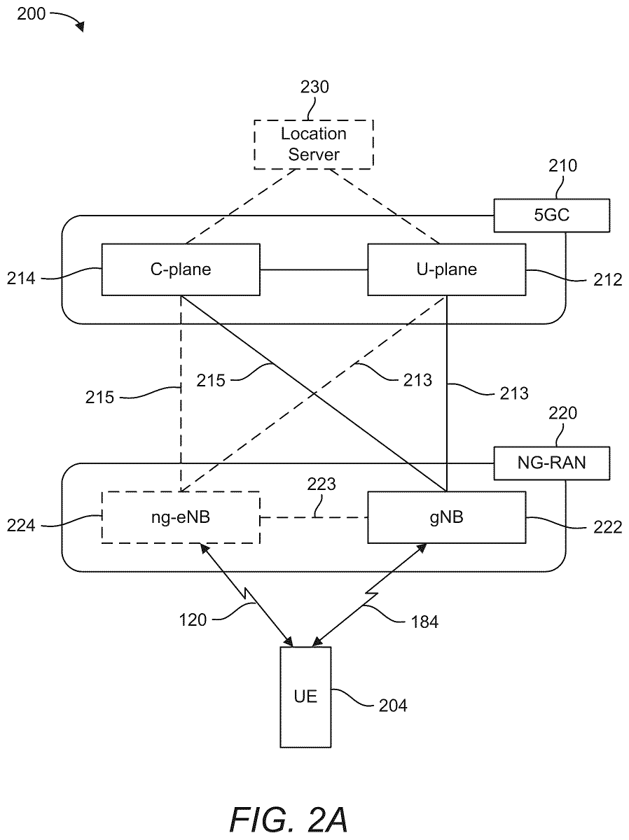

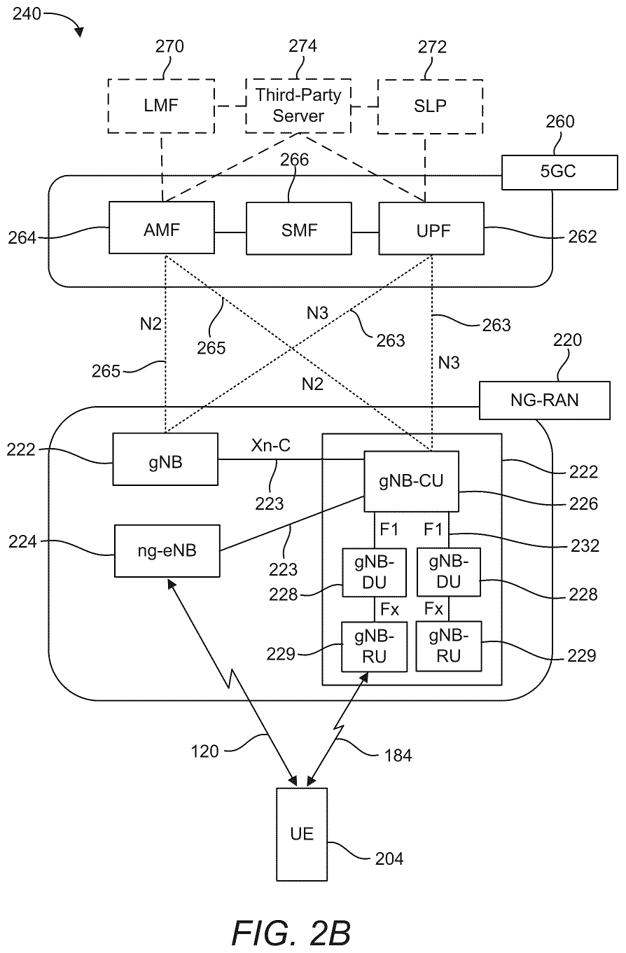

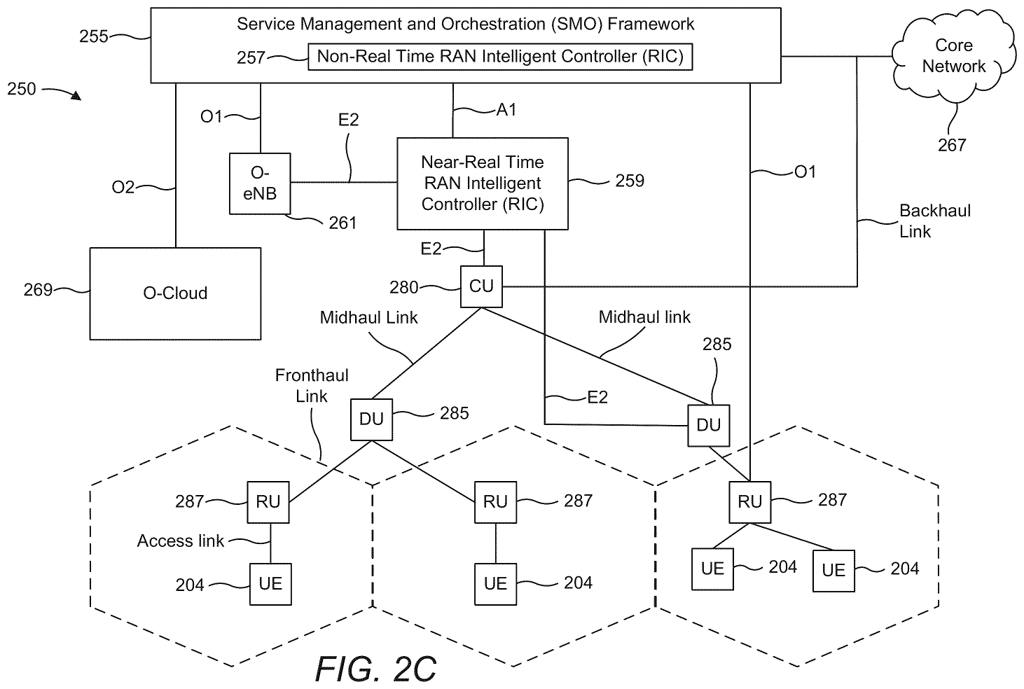

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP® (Third Generation Partnership Project) access networks.

Functions of the UPF 262 include acting as an anchor point for intra/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QOS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

Deployment of communication systems, such as 5G NR systems, may be arranged in multiple manners with various components or constituent parts. In a 5G NR system, or network, a network node, a network entity, a mobility element of a network, a RAN node, a core network node, a network element, or a network equipment, such as a base station, or one or more units (or one or more components) performing base station functionality, may be implemented in an aggregated or disaggregated architecture. For example, a base station (such as a Node B (NB), evolved NB (eNB), NR base station, 5G NB, AP, TRP, cell, etc.) may be implemented as an aggregated base station (also known as a standalone base station or a monolithic base station) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN ALLIANCE®)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

FIG. 2C illustrates an example disaggregated base station architecture 250, according to aspects of the disclosure. The disaggregated base station architecture 250 may include one or more central units (CUs) 280 (e.g., gNB-CU 226) that can communicate directly with a core network 267 (e.g., 5GC 210, 5GC 260) via a backhaul link, or indirectly with the core network 267 through one or more disaggregated base station units (such as a Near-Real Time (Near-RT) RAN Intelligent Controller (RIC) 259 via an E2 link, or a Non-Real Time (Non-RT) RIC 257 associated with a Service Management and Orchestration (SMO) Framework 255, or both). A CU 280 may communicate with one or more DUs 285 (e.g., gNB-DUs 228) via respective midhaul links, such as an F1 interface. The DUs 285 may communicate with one or more radio units (RUS) 287 (e.g., gNB-RUs 229) via respective fronthaul links. The RUs 287 may communicate with respective UEs 204 via one or more RF access links. In some implementations, the UE 204 may be simultaneously served by multiple RUs 287.

Each of the units, i.e., the CUS 280, the DUs 285, the RUs 287, as well as the Near-RT RICs 259, the Non-RT RICs 257 and the SMO Framework 255, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a RF transceiver), configured to receive or transmit signals, or both, over a wireless transmission medium to one or more of the other units.

In some aspects, the CU 280 may host one or more higher layer control functions. Such control functions can include RRC, PDCP, service data adaptation protocol (SDAP), or the like. Each control function can be implemented with an interface configured to communicate signals with other control functions hosted by the CU 280. The CU 280 may be configured to handle user plane functionality (i.e., Central Unit-User Plane (CU-UP)), control plane functionality (i.e., Central Unit-Control Plane (CU-CP)), or a combination thereof. In some implementations, the CU 280 can be logically split into one or more CU-UP units and one or more CU-CP units. The CU-UP unit can communicate bidirectionally with the CU-CP unit via an interface, such as the E1 interface when implemented in an O-RAN configuration. The CU 280 can be implemented to communicate with the DU 285, as necessary, for network control and signaling.

The DU 285 may correspond to a logical unit that includes one or more base station functions to control the operation of one or more RUs 287. In some aspects, the DU 285 may host one or more of a RLC layer, a MAC layer, and one or more high PHY layers (such as modules for forward error correction (FEC) encoding and decoding, scrambling, modulation and demodulation, or the like) depending, at least in part, on a functional split, such as those defined by the 3rd Generation Partnership Project (3GPP®). In some aspects, the DU 285 may further host one or more low PHY layers. Each layer (or module) can be implemented with an interface configured to communicate signals with other layers (and modules) hosted by the DU 285, or with the control functions hosted by the CU 280.

Lower-layer functionality can be implemented by one or more RUs 287. In some deployments, an RU 287, controlled by a DU 285, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 287 can be implemented to handle over the air (OTA) communication with one or more UEs 204. In some implementations, real-time and non-real-time aspects of control and user plane communication with the RU(s) 287 can be controlled by the corresponding DU 285. In some scenarios, this configuration can enable the DU(s) 285 and the CU 280 to be implemented in a cloud-based RAN architecture, such as a vRAN architecture.

The SMO Framework 255 may be configured to support RAN deployment and provisioning of non-virtualized and virtualized network elements. For non-virtualized network elements, the SMO Framework 255 may be configured to support the deployment of dedicated physical resources for RAN coverage requirements which may be managed via an operations and maintenance interface (such as an O1 interface). For virtualized network elements, the SMO Framework 255 may be configured to interact with a cloud computing platform (such as an open cloud (O-Cloud) 269) to perform network element life cycle management (such as to instantiate virtualized network elements) via a cloud computing platform interface (such as an O2 interface). Such virtualized network elements can include, but are not limited to, CUs 280, DUs 285, RUS 287 and Near-RT RICs 259. In some implementations, the SMO Framework 255 can communicate with a hardware aspect of a 4G RAN, such as an open eNB (O-eNB) 261, via an O1 interface. Additionally, in some implementations, the SMO Framework 255 can communicate directly with one or more RUs 287 via an O1 interface. The SMO Framework 255 also may include a Non-RT RIC 257 configured to support functionality of the SMO Framework 255.

The Non-RT RIC 257 may be configured to include a logical function that enables non-real-time control and optimization of RAN elements and resources, artificial intelligence/machine learning (AI/ML) workflows including model training and updates, or policy-based guidance of applications/features in the Near-RT RIC 259. The Non-RT RIC 257 may be coupled to or communicate with (such as via an A1 interface) the Near-RT RIC 259. The Near-RT RIC 259 may be configured to include a logical function that enables near-real-time control and optimization of RAN elements and resources via data collection and actions over an interface (such as via an E2 interface) connecting one or more CUs 280, one or more DUs 285, or both, as well as an O-eNB, with the Near-RT RIC 259.

In some implementations, to generate AI/ML models to be deployed in the Near-RT RIC 259, the Non-RT RIC 257 may receive parameters or external enrichment information from external servers. Such information may be utilized by the Near-RT RIC 259 and may be received at the SMO Framework 255 or the Non-RT RIC 257 from non-network data sources or from network functions. In some examples, the Non-RT RIC 257 or the Near-RT RIC 259 may be configured to tune RAN behavior or performance. For example, the Non-RT RIC 257 may monitor long-term trends and patterns for performance and employ AI/ML models to perform corrective actions through the SMO Framework 255 (such as reconfiguration via O1) or via creation of RAN management policies (such as A1 policies).

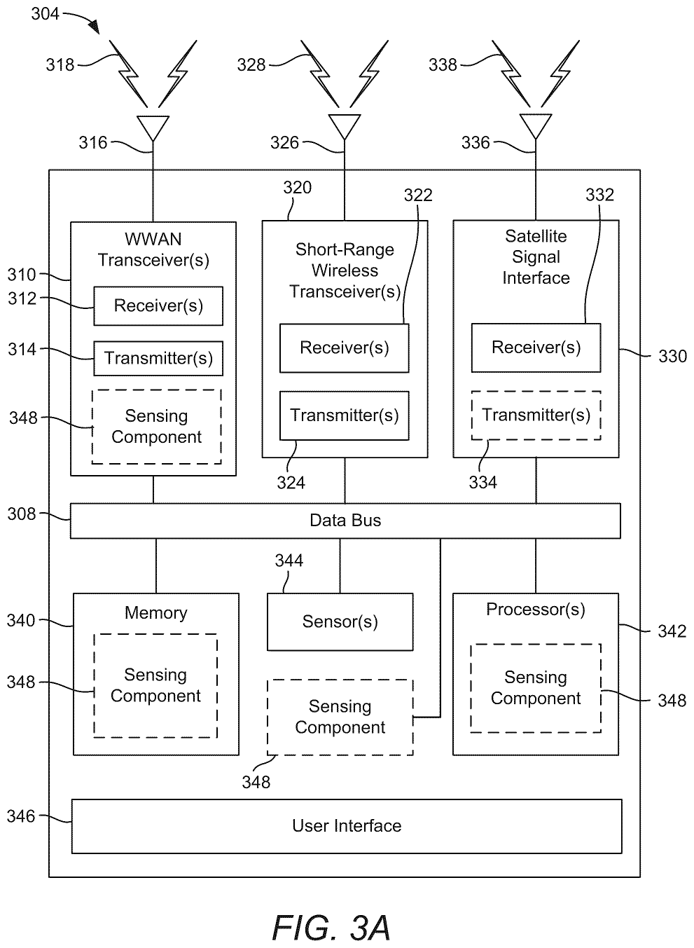

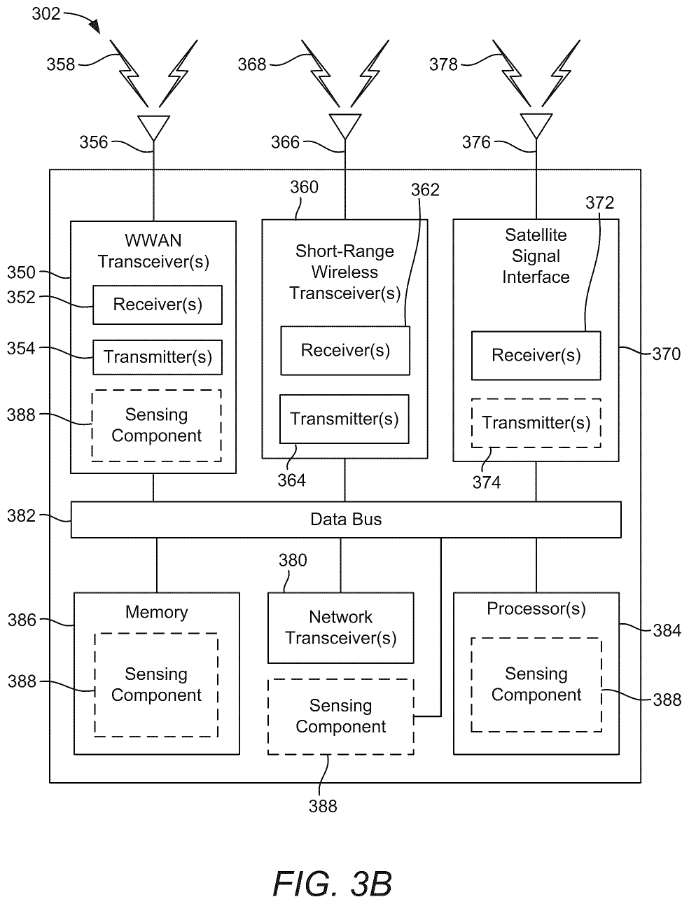

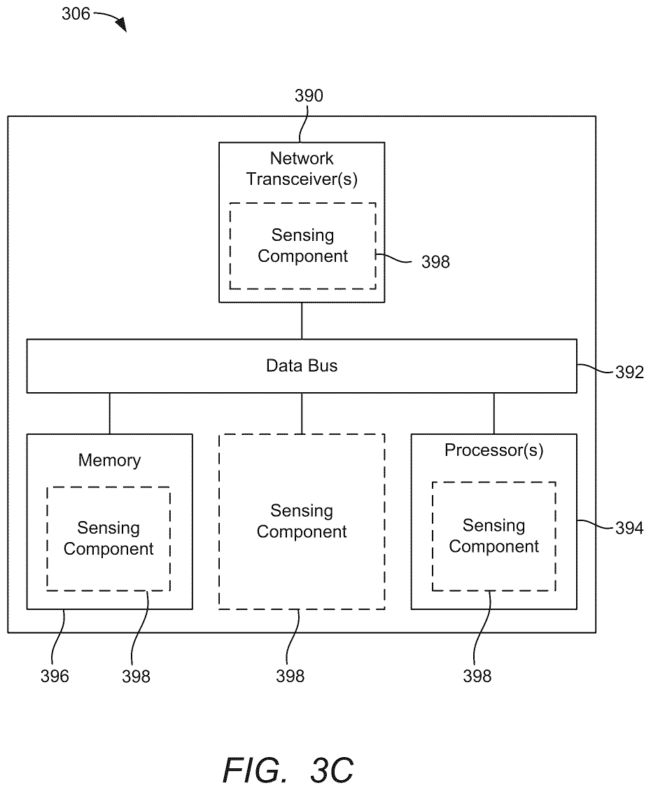

FIGS. 3A, 3B, and 3C illustrate several example components (represented by corresponding blocks) that may be incorporated into a UE 304 (which may correspond to any of the UEs described herein), a base station 302 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 304 and the base station 302 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 304 and the base station 302 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., Wi-Fi, LTE Direct, BLUETOOTH®, ZIGBEE®, Z-WAVE®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be Wi-Fi transceivers, BLUETOOTH® transceivers, ZIGBEE® and/or Z-WAVE® transceivers, NFC transceivers, UWB transceivers, or vehicle-to-vehicle (V2V) and/or vehicle-to-everything (V2X) transceivers.

The UE 304 and the base station 302 also include, at least in some cases, satellite signal interfaces 330 and 370, which each include one or more satellite signal receivers 332 and 372, respectively, and may optionally include one or more satellite signal transmitters 334 and 374, respectively. In some cases, the base station 302 may be a terrestrial base station that may communicate with space vehicles (e.g., space vehicles 112) via the satellite signal interface 370. In other cases, the base station 302 may be a space vehicle (or other non-terrestrial entity) that uses the satellite signal interface 370 to communicate with terrestrial networks and/or other space vehicles.

The satellite signal receivers 332 and 372 may be connected to one or more antennas 336 and 376, respectively, and may provide means for receiving and/or measuring satellite positioning/communication signals 338 and 378, respectively. Where the satellite signal receiver(s) 332 and 372 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS) signals, etc. Where the satellite signal receiver(s) 332 and 372 are non-terrestrial network (NTN) receivers, the satellite positioning/communication signals 338 and 378 may be communication signals (e.g., carrying control and/or user data) originating from a 5G network. The satellite signal receiver(s) 332 and 372 may comprise any suitable hardware and/or software for receiving and processing satellite positioning/communication signals 338 and 378, respectively. The satellite signal receiver(s) 332 and 372 may request information and operations as appropriate from the other systems, and, at least in some cases, perform calculations to determine locations of the UE 304 and the base station 302, respectively, using measurements obtained by any suitable satellite positioning system algorithm.

The optional satellite signal transmitter(s) 334 and 374, when present, may be connected to the one or more antennas 336 and 376, respectively, and may provide means for transmitting satellite positioning/communication signals 338 and 378, respectively. Where the satellite signal transmitter(s) 374 are satellite positioning system transmitters, the satellite positioning/communication signals 378 may be GPS signals, GLONASS® signals, Galileo signals, Beidou signals, NAVIC, QZSS signals, etc. Where the satellite signal transmitter(s) 334 and 374 are NTN transmitters, the satellite positioning/communication signals 338 and 378 may be communication signals (e.g., carrying control and/or user data) originating from a 5G network. The satellite signal transmitter(s) 334 and 374 may comprise any suitable hardware and/or software for transmitting satellite positioning/communication signals 338 and 378, respectively. The satellite signal transmitter(s) 334 and 374 may request information and operations as appropriate from the other systems.

The base station 302 and the network entity 306 each include one or more network transceivers 380 and 390, respectively, providing means for communicating (e.g., means for transmitting, means for receiving, etc.) with other network entities (e.g., other base stations 302, other network entities 306). For example, the base station 302 may employ the one or more network transceivers 380 to communicate with other base stations 302 or network entities 306 over one or more wired or wireless backhaul links. As another example, the network entity 306 may employ the one or more network transceivers 390 to communicate with one or more base station 302 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 304, base station 302) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 304, base station 302) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 304) and a base station (e.g., base station 302) will generally relate to signaling via a wireless transceiver.

The UE 304, the base station 302, and the network entity 306 also include other components that may be used in conjunction with the operations as disclosed herein. The UE 304, the base station 302, and the network entity 306 include one or more processors 342, 384, and 394, respectively, for providing functionality relating to, for example, wireless communication, and for providing other processing functionality. The processors 342, 384, and 394 may therefore provide means for processing, such as means for determining, means for calculating, means for receiving, means for transmitting, means for indicating, etc. In an aspect, the processors 342, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 304, the base station 302, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 304, the base station 302, and the network entity 306 may include sensing component 348, 388, and 398, respectively. The sensing component 348, 388, and 398 may be hardware circuits that are part of or coupled to the processors 342, 384, and 394, respectively, that, when executed, cause the UE 304, the base station 302, and the network entity 306 to perform the functionality described herein. In other aspects, the sensing component 348, 388, and 398 may be external to the processors 342, 384, and 394 (e.g., part of a modem processing system, integrated with another processing system, etc.). Alternatively, the sensing component 348, 388, and 398 may be memory modules stored in the memories 340, 386, and 396, respectively, that, when executed by the processors 342, 384, and 394 (or a modem processing system, another processing system, etc.), cause the UE 304, the base station 302, and the network entity 306 to perform the functionality described herein. FIG. 3A illustrates possible locations of the sensing component 348, which may be, for example, part of the one or more WWAN transceivers 310, the memory 340, the one or more processors 342, or any combination thereof, or may be a standalone component. FIG. 3B illustrates possible locations of the sensing component 388, which may be, for example, part of the one or more WWAN transceivers 350, the memory 386, the one or more processors 384, or any combination thereof, or may be a standalone component. FIG. 3C illustrates possible locations of the sensing component 398, which may be, for example, part of the one or more network transceivers 390, the memory 396, the one or more processors 394, or any combination thereof, or may be a standalone component.

The UE 304 may include one or more sensors 344 coupled to the one or more processors 342 to provide means for sensing or detecting movement and/or orientation information that is independent of motion data derived from signals received by the one or more WWAN transceivers 310, the one or more short-range wireless transceivers 320, and/or the satellite signal interface 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 304 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 302 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging. RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 304. Each spatial stream may then be provided to one or more different antennas 356. The transmitter 354 may modulate an RF carrier with a respective spatial stream for transmission.

At the UE 304, the receiver 312 receives a signal through its respective antenna(s) 316. The receiver 312 recovers information modulated onto an RF carrier and provides the information to the one or more processors 342. The transmitter 314 and the receiver 312 implement Layer-1 functionality associated with various signal processing functions. The receiver 312 may perform spatial processing on the information to recover any spatial streams destined for the UE 304. If multiple spatial streams are destined for the UE 304, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 302. These soft decisions may be based on channel estimates computed by a channel estimator. The soft decisions are then decoded and de-interleaved to recover the data and control signals that were originally transmitted by the base station 302 on the physical channel. The data and control signals are then provided to the one or more processors 342, which implements Layer-3 (L3) and Layer-2 (L2) functionality.

In the downlink, the one or more processors 342 provides demultiplexing between transport and logical channels, packet reassembly, deciphering, header decompression, and control signal processing to recover IP packets from the core network. The one or more processors 342 are also responsible for error detection.

Similar to the functionality described in connection with the downlink transmission by the base station 302, the one or more processors 342 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 302 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 302 in a manner similar to that described in connection with the receiver function at the UE 304. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 304. IP packets from the one or more processors 384 may be provided to the core network. The one or more processors 384 are also responsible for error detection.

For convenience, the UE 304, the base station 302, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 304 may omit the WWAN transceiver(s) 310 (e.g., a wearable device or tablet computer or personal computer (PC) or laptop may have Wi-Fi and/or BLUETOOTH® capability without cellular capability), or may omit the short-range wireless transceiver(s) 320 (e.g., cellular-only, etc.), or may omit the satellite signal interface 330, or may omit the sensor(s) 344, and so on. In another example, in case of FIG. 3B, a particular implementation of the base station 302 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal interface 370, and so on. For brevity, illustration of the various alternative configurations is not provided herein, but would be readily understandable to one skilled in the art.

The various components of the UE 304, the base station 302, and the network entity 306 may be communicatively coupled to each other over data buses 308, 382, and 392, respectively. In an aspect, the data buses 308, 382, and 392 may form, or be part of, a communication interface of the UE 304, the base station 302, and the network entity 306, respectively. For example, where different logical entities are embodied in the same device (e.g., gNB and location server functionality incorporated into the same base station 302), the data buses 308, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 304 (e.g., by execution of appropriate code and/or by appropriate configuration of processor components). Similarly, some or all of the functionality represented by blocks 350 to 388 may be implemented by processor and memory component(s) of the base station 302 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 304, base station 302, network entity 306, etc., such as the processors 342, 384, 394, the transceivers 310, 320, 350, and 360, the memories 340, 386, and 396, the sensing component 348, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 304 via the base station 302 or independently from the base station 302 (e.g., over a non-cellular communication link, such as Wi-Fi).

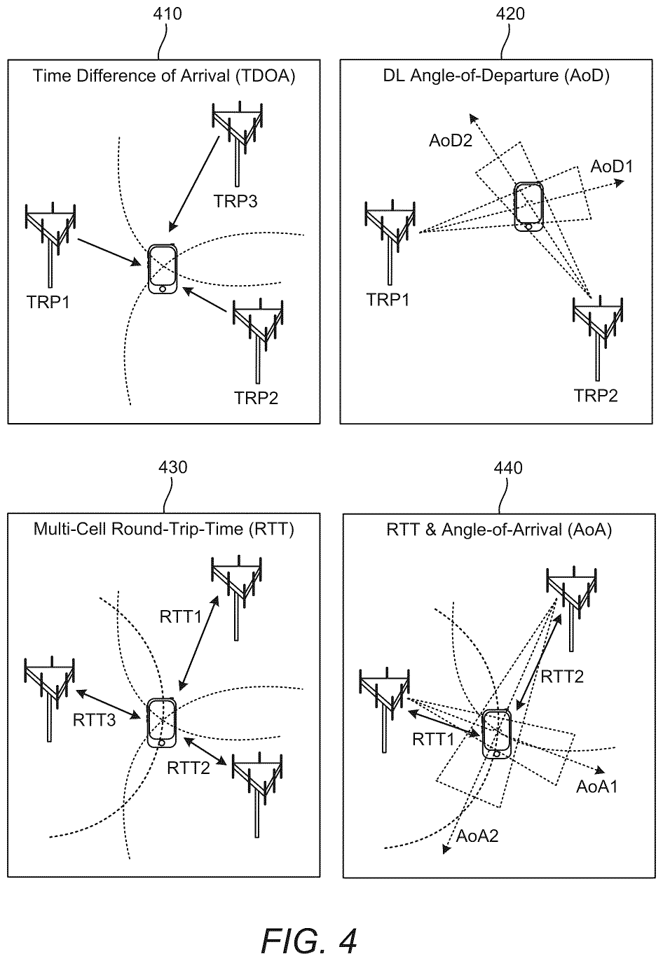

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. FIG. 4 illustrates examples of various positioning methods, according to aspects of the disclosure. In an OTDOA or DL-TDOA positioning procedure, illustrated by scenario 410, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, illustrated by scenario 420, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, illustrated by scenario 430, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy, as illustrated by scenario 440.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

Long-Term Evolution (LTE) positioning protocol (LPP) is used point-to-point between a location server (e.g., LMF 270) and a target device (e.g., a UE) in order to position the target device using position-related measurements obtained by one or more reference sources (physical entities or parts of physical entities that provide signals that can be measured by a target device in order to obtain the location of the target device). An LPP session is used between a location server and a target device in order to obtain location-related measurements or a location estimate or to transfer assistance data. Currently, a single LPP session is used to support a single location request and multiple LPP sessions can be used between the same endpoints to support multiple different location requests. Each LPP session comprises one or more LPP transactions (or procedures), with each LPP transaction performing a single operation (capability exchange, assistance data transfer, or location information transfer). Each LPP transaction involves the exchange of one or more LPP messages between the location server and the target device. The general format of an LPP message consists of a set of common fields followed by a body. The body (which may be empty) contains information specific to a particular message type. Each message type contains information specific to one or more positioning methods and/or information common to all positioning methods.

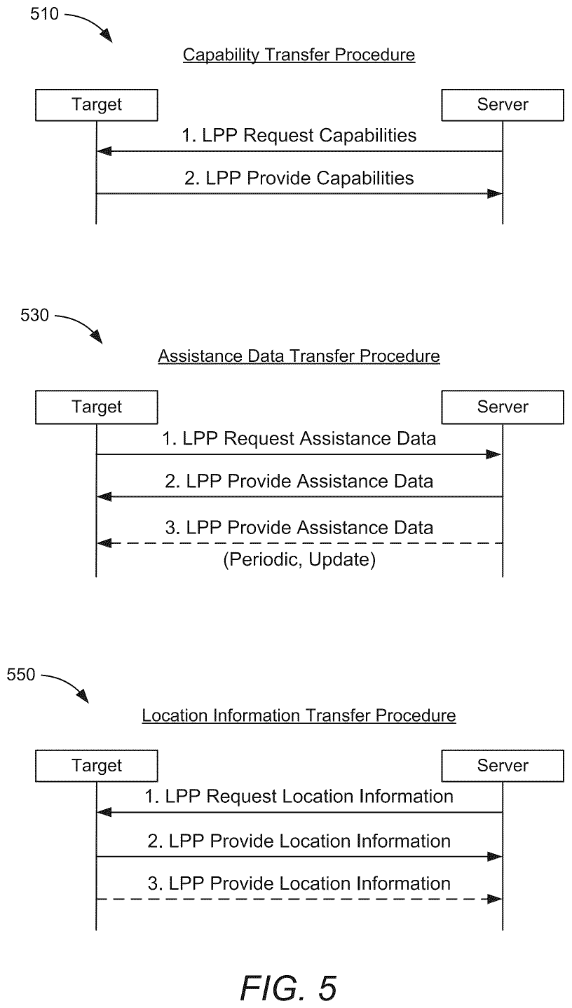

An LPP session generally includes at least a capability transfer or indication procedure, an assistance data transfer or delivery procedure, and a location information transfer or delivery procedure. FIG. 5 illustrates an example LPP capability transfer procedure 510, LPP assistance data transfer procedure 530, and LPP location information transfer procedure 550 between a target device (labeled “Target”) and a location server (labeled “Server”), according to aspects of the disclosure.

The purpose of an LPP capability transfer procedure 510 is to enable the transfer of capabilities from the target device (e.g., a UE 204) to the location server (e.g., an LMF 270). Capabilities in this context refer to positioning and protocol capabilities related to LPP and the positioning methods supported by LPP. In the LPP capability transfer procedure 510, the location server (e.g., an LMF 270) indicates the types of capabilities needed from the target device (e.g., UE 204) in an LPP Request Capabilities message. The target device responds with an LPP Provide Capabilities message. The capabilities included in the LPP Provide Capabilities message should correspond to any capability types specified in the LPP Request Capabilities message. Specifically, for each positioning method for which a request for capabilities is included in the LPP Request Capabilities message, if the target device supports this positioning method, the target device includes the capabilities of the target device for that supported positioning method in the LPP Provide Capabilities message. For an LPP capability indication procedure, the target device provides unsolicited (i.e., without receiving an LPP Request Capabilities message) capabilities to the location server in an LPP Provide Capabilities message.

The purpose of an LPP assistance data transfer procedure 530 is to enable the target device to request assistance data from the location server to assist in positioning, and to enable the location server to transfer assistance data to the target device in the absence of a request. In the LPP assistance data transfer procedure 530, the target device sends an LPP Request Assistance Data message to the location server. The location server responds to the target device with an LPP Provide Assistance Data message containing assistance data. The transferred assistance data should match or be a subset of the assistance data requested in the LPP Request Assistance Data. The location server may also provide any not requested information that it considers useful to the target device. The location server may also transmit one or more additional LPP Provide Assistance Data messages to the target device containing further assistance data. For an LPP assistance data delivery procedure, the location server provides unsolicited assistance data necessary for positioning. The assistance data may be provided periodically or non-periodically.

The purpose of an LPP location information transfer procedure 550 is to enable the location server to request location measurement data and/or a location estimate from the target device, and to enable the target device to transfer location measurement data and/or a location estimate to a location server in the absence of a request. In an LPP location information transfer procedure 550, the location server sends an LPP Request Location Information message to the target device to request location information, indicating the type of location information needed and potentially the associated QoS. The target device responds with an LPP Provide Location Information message to the location server to transfer location information. The location information transferred should match or be a subset of the location information requested by the LPP Request Location Information unless the location server explicitly allows additional location information. More specifically, if the requested information is compatible with the target device's capabilities and configuration, the target device includes the requested information in an LPP Provide Location Information message. Otherwise, if the target device does not support one or more of the requested positioning methods, the target device continues to process the message as if it contained only information for the supported positioning methods and handles the signaling content of the unsupported positioning methods by LPP error detection. If requested by the LPP Request Lactation Information message, the target device sends additional LPP Provide Location Information messages to the location server to transfer additional location information. An LPP location information delivery procedure supports the delivery of positioning estimations based on unsolicited service.

LPP also defines procedures related to error indication for when a receiving endpoint (target device or location server) receives erroneous or unexpected data or detects that certain data are missing. Specifically, when a receiving endpoint determines that a received LPP message contains an error, it can return an Error message to the transmitting endpoint indicating the error or errors and discard the received/erroneous message. If the receiving endpoint is able to determine that the erroneous LPP message is an LPP Error or Abort Message, then the receiving endpoint discards the received message without returning an Error message to the transmitting endpoint.

LPP also defines procedures related to abort indication to allow a target device or location server to abort an ongoing procedure due to some unexpected event (e.g., cancellation of a location request by an LCS client). An Abort procedure can also be used to stop an ongoing procedure (e.g., periodic location reporting from the target device). In an Abort procedure, a first endpoint determines that procedure P must be aborted and sends an Abort message to a second endpoint carrying the transaction ID for procedure P. The second endpoint then aborts procedure P.

Wireless communication signals (e.g., RF signals configured to carry orthogonal frequency division multiplexing (OFDM) symbols in accordance with a wireless communications standard, such as LTE, NR, etc.) transmitted between a UE and a base station can be used for environment sensing (also referred to as “RF sensing” or “radar”). Using wireless communication signals for environment sensing can be regarded as consumer-level radar with advanced detection capabilities that enable, among other things, touchless/device-free interaction with a device/system. The wireless communication signals may be cellular communication signals, such as LTE or NR signals, WLAN signals, such as Wi-Fi signals, etc. As a particular example, the wireless communication signals may be an OFDM waveform as utilized in LTE and NR. High-frequency communication signals, such as millimeter wave (mmW) RF signals, are especially beneficial to use as radar signals because the higher frequency provides, at least, more accurate range (distance) detection.

Possible use cases of RF sensing include health monitoring use cases, such as heartbeat detection, respiration rate monitoring, and the like, gesture recognition use cases, such as human activity recognition, keystroke detection, sign language recognition, and the like, contextual information acquisition use cases, such as location detection/tracking, direction finding, range estimation, and the like, and automotive radar use cases, such as smart cruise control, collision avoidance, and the like.

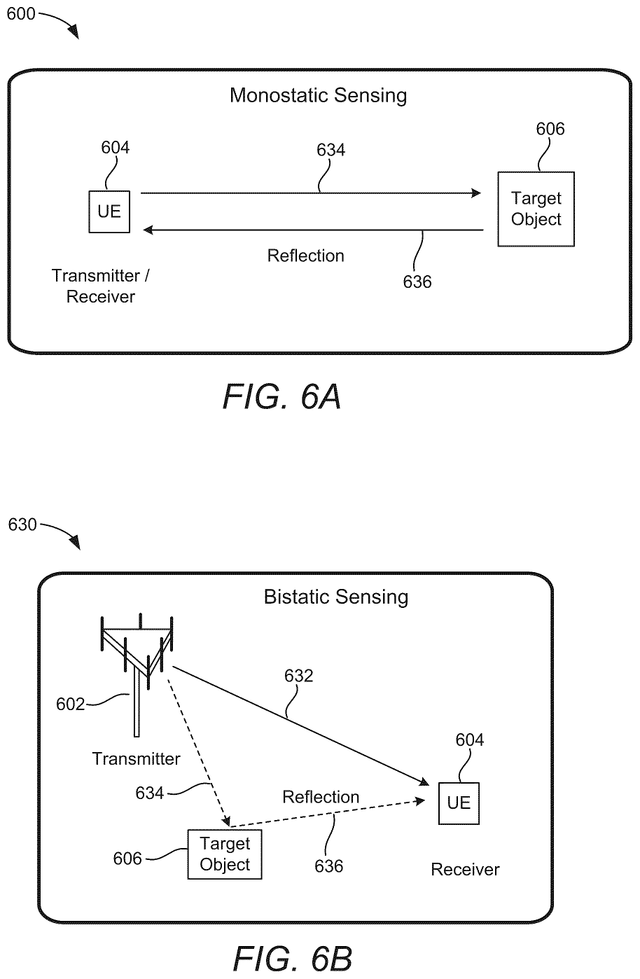

There are different types of sensing, including monostatic sensing (also referred to as “active sensing”) and bistatic sensing (also referred to as “passive sensing”). FIGS. 6A and 6B illustrate these different types of sensing. Specifically, FIG. 6A is a diagram 600 illustrating a monostatic sensing scenario and FIG. 6B is a diagram 630 illustrating a bistatic sensing scenario. In FIG. 6A, the transmitter (Tx) and receiver (Rx) are co-located in the same sensing device 604 (e.g., a UE). The sensing device 604 transmits one or more RF sensing signals 634 (e.g., uplink or sidelink positioning reference signals (PRS) where the sensing device 604 is a UE), and some of the RF sensing signals 634 reflect off a target object 606. The sensing device 604 can measure various properties (e.g., times of arrival (ToAs), angles of arrival (AoAs), phase shift, etc.) of the reflections 636 of the RF sensing signals 634 to determine characteristics of the target object 606 (e.g., size, shape, speed, motion state, etc.).

In FIG. 6B, the transmitter (Tx) and receiver (Rx) are not co-located, that is, they are separate devices (e.g., a UE and a base station). Note that while FIG. 6B illustrates using a downlink RF signal as the RF sensing signal 632, uplink RF signals or sidelink RF signals can also be used as RF sensing signals 632. In a downlink scenario, as shown, the transmitter is a base station and the receiver is a UE, whereas in an uplink scenario, the transmitter is a UE and the receiver is a base station.

Referring to FIG. 6B in greater detail, the transmitter device 602 transmits RF sensing signals 632 and 634 (e.g., positioning reference signals (PRS)) to the sensing device 604, but some of the RF sensing signals 634 reflect off a target object 606. The sensing device 604 (also referred to as the “sensing device”) can measure the times of arrival (ToAs) of the RF sensing signals 632 received directly from the transmitter device and the ToAs of the reflections 636 of the RF sensing signals 634 reflected from the target object 606.

More specifically, as described above, a transmitter device (e.g., a base station) may transmit a single RF signal or multiple RF signals to a sensing device (e.g., a UE). However, the receiver may receive multiple RF signals corresponding to each transmitted RF signal due to the propagation characteristics of RF signals through multipath channels. Each path may be associated with a cluster of one or more channel taps. Generally, the time at which the receiver detects the first cluster of channel taps is considered the ToA of the RF signal on the line-of-site (LOS) path (i.e., the shortest path between the transmitter and the receiver). Later clusters of channel taps are considered to have reflected off objects between the transmitter and the receiver and therefore to have followed non-LOS (NLOS) paths between the transmitter and the receiver.

Thus, referring back to FIG. 6B, the RF sensing signals 632 followed the LOS path between the transmitter device 602 and the sensing device 604, and the RF sensing signals 634 followed an NLOS path between the transmitter device 602 and the sensing device 604 due to reflecting off the target object 606. The transmitter device 602 may have transmitted multiple RF sensing signals 632, 634, some of which followed the LOS path and others of which followed the NLOS path. Alternatively, the transmitter device 602 may have transmitted a single RF sensing signal in a broad enough beam that a portion of the RF sensing signal followed the LOS path (RF sensing signal 632) and a portion of the RF sensing signal followed the NLOS path (RF sensing signal 634).

Based on the ToA of the LOS path, the ToA of the NLOS path, and the speed of light, the sensing device 604 can determine the distance to the target object(s). For example, the sensing device 604 can calculate the distance to the target object as the difference between the ToA of the LOS path and the ToA of the NLOS path multiplied by the speed of light. In addition, if the sensing device 604 is capable of receive beamforming, the sensing device 604 may be able to determine the general direction to a target object as the direction (angle) of the receive beam on which the RF sensing signal following the NLOS path was received. That is, the sensing device 604 may determine the direction to the target object as the angle of arrival (AoA) of the RF sensing signal, which is the angle of the receive beam used to receive the RF sensing signal. The sensing device 604 may then optionally report this information to the transmitter device 602, its serving base station, an application server associated with the core network, an external client, a third-party application, or some other sensing entity. Alternatively, the sensing device 604 may report the ToA measurements to the transmitter device 602, or other sensing entity (e.g., if the sensing device 604 does not have the processing capability to perform the calculations itself), and the transmitter device 602 may determine the distance and, optionally, the direction to the target object 606.

Note that if the RF sensing signals are uplink RF signals transmitted by a UE to a base station, the base station would perform object detection based on the uplink RF signals just like the UE does based on the downlink RF signals.

Like conventional radar, wireless communication-based radar signal can be used to estimate the range (distance), velocity (Doppler), and angle (AoA) of a target object. However, the performance (e.g., resolution and maximum values of range, velocity, and angle) may depend on the design of the reference signal.

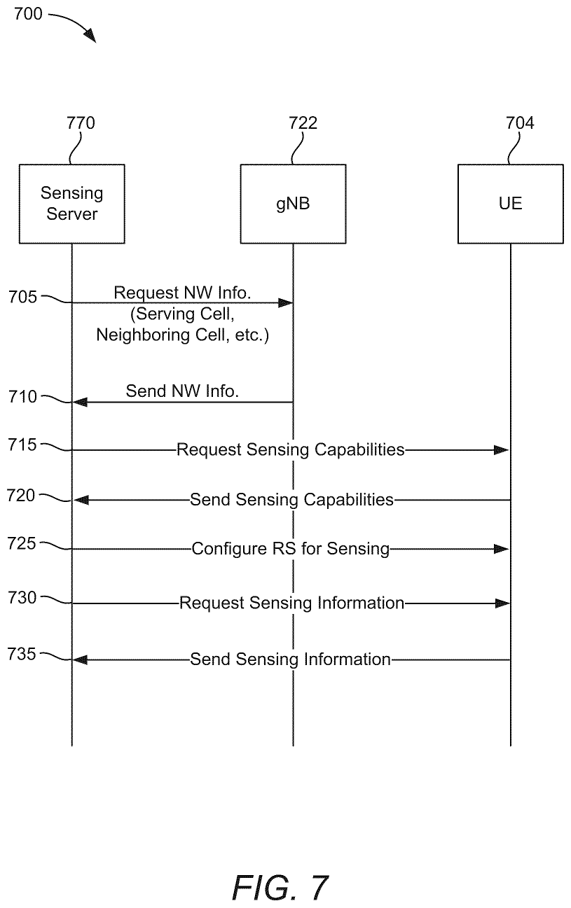

FIG. 7 illustrates an example call flow 700 for an NR-based sensing procedure (e.g., a bistatic sensing procedure) in which the network configures the sensing parameters, according to aspects of the disclosure. Although FIG. 7 illustrates a network-coordinated sensing procedure, the sensing procedure could be coordinated over sidelink channels.

At stage 705, a sensing server 770 (e.g., inside or outside the core network) sends a request for network (NW) information to a gNB 722 (e.g., the serving gNB of a UE 704). The request may be for a list of the UE's 704 serving cell and any neighboring cells. At stage 710, the gNB 722 sends the requested information to the sensing server 770. At stage 715, the sensing server 770 sends a request for sensing capabilities to the UE 704. At stage 720, the UE 704 provides its sensing capabilities to the sensing server 770.

At stage 725, the sensing server 770 sends a configuration to the UE 704 indicating one or more reference signal (RS) resources that will be transmitted for sensing. The reference signal resources may be transmitted by the serving and/or neighboring cells identified at stage 710. In some cases, the NR-based sensing procedure illustrated in FIG. 7 may be a sensing-only procedure or a joint communication and sensing (JCS) procedure. In the case of a sensing-only procedure, the reference signal resources may be reference signal resources specifically configured for sensing purposes. In the case of a JCS procedure, the reference signal resources may be reference signal resources for communication that can also be used for sensing purposes. Alternatively, the reference signal resources for sensing may be multiplexed (e.g., time-division multiplexed) with reference signal resources for communication. For example, the reference signal resources for communication may be an orthogonal frequency division multiplexing (OFDM) waveform, while the reference signal resources for sensing may be a frequency modulation continuous wave (FMCW) waveform.

At stage 730, the sensing server 770 sends a request for sensing information to the UE 704. The UE 704 then measures the transmitted reference signals and, at stage 735, sends the measurements, or any sensing results determined from the measurements, to the sensing server 770.

In an aspect, the communication between the UE 704 and the sensing server 770 may be via the LTE positioning protocol (LPP). The communication between the sensing server 770 and the gNB may be via NR positioning protocol type A (NRPPa).

Aspects of the disclosure relate to techniques for measurement and reporting of CTIs and PTIs associated with RF sensing operations. In various wireless network architectures, such as 5G NR Advanced and 3GPP® sixth generation (6G) wireless networks RF sensing operations may be included in various use cases. Some non-limiting use cases for RF sensing operations include target detection in factory environments or predefined secure areas, collision avoidance and trajectory tracking of vehicles, unmanned aerial vehicles (UAVs), automated guided vehicles (AGVs), etc. as well as automotive maneuvering and navigation. Certain implementations involving RF sensing may pose challenges depending on various characteristics, such as propagation environment (e.g., outdoor or indoor environments, LOS or NLOS signal paths, etc.) or the sensing frequency used (e.g., FR1, FR2, FR4, FR4-a or FR4-1, and/or FR5).

In some examples, use cases may be tailored for private networks and warehouses. That is, for example, RF sensing operations may be used to improve safety and work conditions in factories and industrial environments. In some cases, reliable detection of AGV and/or human presence or proximity can be an important safety criterion. Some factories and industrial environments may be characterized by heavy clutter making the detection of targets challenging. For example, the sensing signal of interest associated with a target can be several orders of magnitude below the clutter reflections (e.g., ˜10-20 dB in some cases). Accordingly, appropriate signal processing techniques may be employed to aid in proper detection of the target. For example, Doppler filtering may be applied to signal processing procedures to assist in reducing some clutter reflections.

In some cases, there may be scenarios in which some signal paths may not be eliminated by applying signal processing techniques due to certain behaviors in a wireless communications system. For example, some wireless communications systems may be subject to transient and/or short dynamic behavior in a factory or industrial environment. That is, while clutter reflections caused by robotic arm movements may be adequately eliminated by applying certain filtering techniques to the corresponding sensing signal, sudden jerky behavior (e.g., sudden acceleration and/or deceleration) in the movement of the robotic arm or other objects can cause Doppler components in the sensing signal that may not be filtered by these filtering and/or other signal processing techniques.

In some cases, the non-filtered signal components may lead to suboptimal performance in a wireless communications system. For example, a sensing node may send a report corresponding to an erroneous observation due to the non-filtered signal components thereby causing unnecessary reporting overhead in the wireless communications system. Additionally, or alternatively, a target localization error may result due to the non-filtered signal components of the sensing node if the target is being detected and localized using multiple sensing nodes in the wireless communications system.

In accordance with some aspects and to overcome challenges that may exist when sensing operations are employed by a wireless communications system in some environments, a sensing node may indicate whether a signal path is likely to have been reflected off a target or is a clutter reflection. Additionally, or alternatively, a sensing node may report whether a specific channel included reflection from a target or only clutter reflections. That is, for example, a channel may be associated with a sensing node configured as a receiving sensing node with a corresponding transmitting sensing node. In some cases, the channel may be associated with a sensing node configured as a transmitting sensing node with a corresponding receiving sensing node.

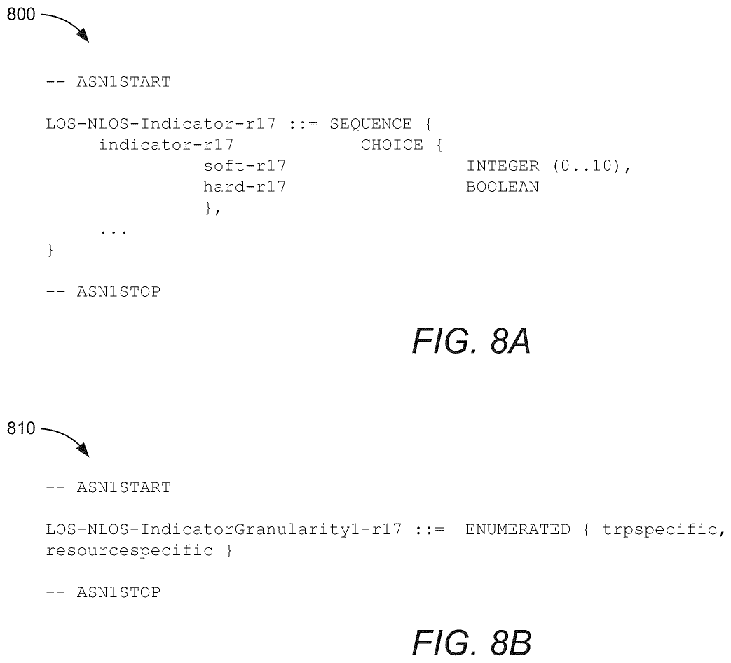

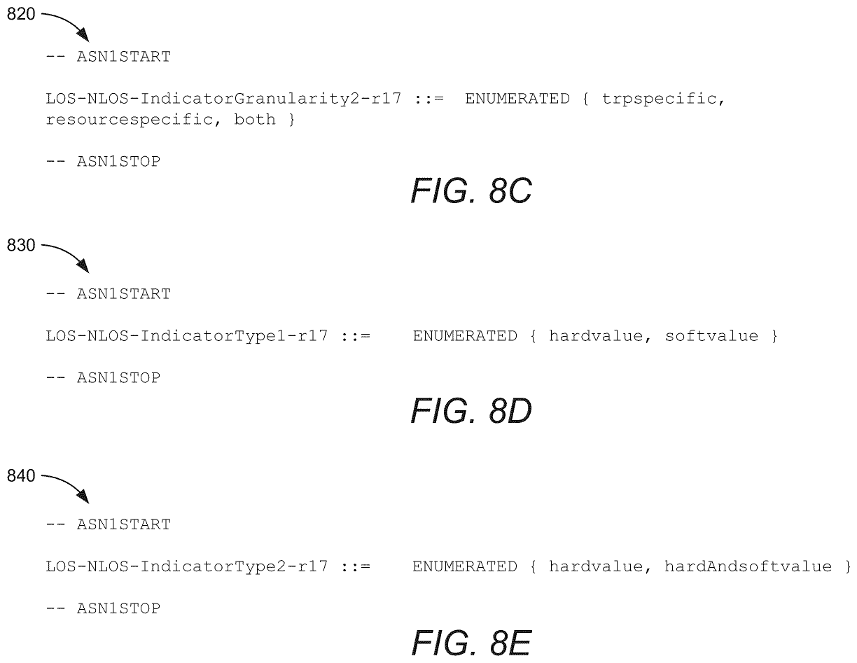

Measurement reports may be used in conjunction with positioning and/or sensing operations. That is, for example, measurement reports may include certain characteristics and/or properties associated with RF transmissions in a wireless channel to enhance the reporting content of the measurement and enable better performance for positioning and/or sensing operations. For example, FIG. 8A illustrates a first example of an LOS-NLOS indicator information element (IE) 800, according to aspects of the disclosure. The first LOS-NLOS indicator IE 800 in the example of FIG. 8A is the IE LOS-NLOS-Indicator which may provide information on the likelihood of an LOS propagation path from the source to the receiver. This indicator field may provide information on the likelihood of an LOS propagation path from the source to the receiver with a value of 1 corresponding to an LOS indication and a value of 0 corresponding to an NLOS indication. In some cases, the indicator may be a soft value. That is, for example, an integer value ‘0’ indicates likelihood 0, integer value ‘1’ indicates likelihood 1. The scale factor of the soft value may include 0.1 increments within the range from 0 to 1. In some cases, the indicator may be a hard value. That is, the indicator may indicate ‘FALSE’ indicating a likelihood of ‘0’, or ‘TRUE’ indicating a likelihood of ‘1’. That is, this field may specify whether the propagation path between the source and the receiver is estimated to be an LOS path (e.g., ‘TRUE’) or an NLOS path (e.g., ‘FALSE’).

FIG. 8B illustrates a second example of an LOS-NLOS indicator IE 810, according to aspects of the disclosure. The second LOS-NLOS indicator IE 810 in the example of FIG. 8B is the IE LOS-NLOS-IndicatorGranularity1 which may provide information on the IE LOS-NLOS-Indicator granularity. FIG. 8C illustrates a third example of an LOS-NLOS indicator IE 820, according to aspects of the disclosure. The third LOS-NLOS indicator IE 820 in the example of FIG. 8C is the IE LOS-NLOS-IndicatorGranularity2 which may also provide information on the IE LOS-NLOS-Indicator granularity.

FIG. 8D illustrates a fourth example of an LOS-NLOS indicator IE 830, according to aspects of the disclosure. The fourth LOS-NLOS indicator IE 830 in the example of FIG. 8D is the IE LOS-NLOS-IndicatorType1 which may provide information on the IE LOS-NLOS-Indicator type that is requested by a location server. FIG. 8E illustrates a fifth example of an LOS-NLOS indicator IE 840, according to aspects of the disclosure. The fifth LOS-NLOS indicator IE 840 in the example of FIG. 8E is the IE LOS-NLOS-IndicatorType2 which may provide information on the IE LOS-NLOS-Indicator type that is supported by a target device.

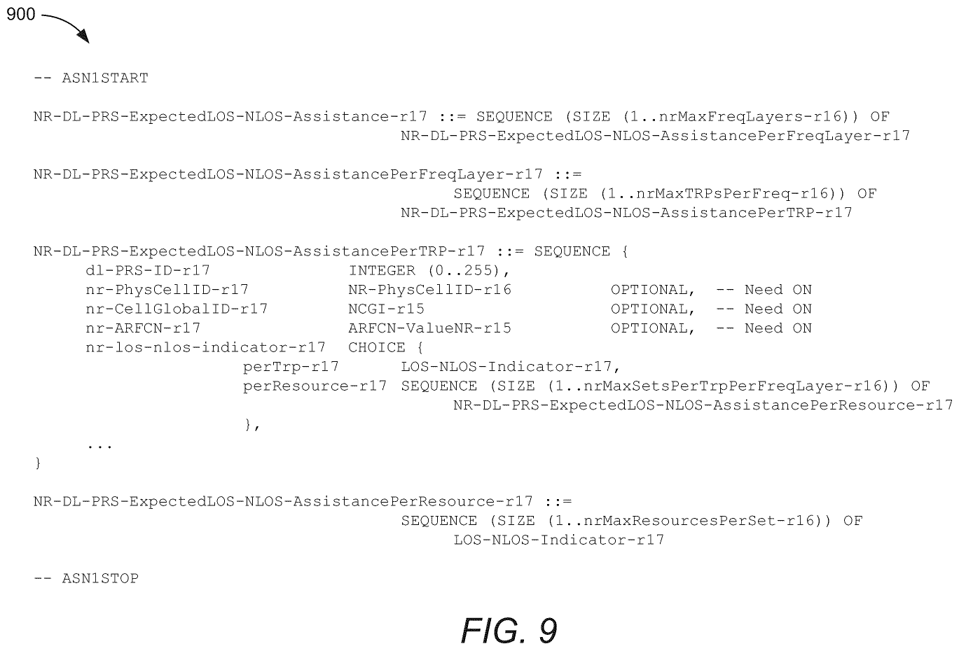

FIG. 9 illustrates an example of an LOS-NLOS assistance data IE 900, according to aspects of the disclosure. The first LOS-NLOS assistance data IE 900 in the example of FIG. 9 is the IE NR-DL-PRS-ExpectedLOS-NLOS-Assistance which may be used by the location server to provide the expected likelihood of a LOS propagation path from a TRP to the target device, or for all DL-PRS resources of the TRP to the target device.

In some examples, the IE NR-DL-PRS-ExpectedLOS-NLOS-Assistance may include a dl-PRS-ID field that specifies the DL-PRS ID of the TRP for which the LOS/NLOS information is provided. The IE NR-DL-PRS-ExpectedLOS-NLOS-Assistance may optionally include an nr-PhysCellID field that specifies the physical Cell-ID of the TRP for which the LOS/NLOS information is provided. The IE NR-DL-PRS-ExpectedLOS-NLOS-Assistance may optionally include an nr-CellGlobalID field that specifies the NCGI (NR cell global identifier), the globally unique identity of a cell in NR, of the TRP for which the LOS/NLOS information is provided. The IE NR-DL-PRS-ExpectedLOS-NLOS-Assistance may optionally include an nr-ARFCN field that specifies the NR-ARFCN (absolute radio frequency channel number) of the TRP's CD-SSB corresponding to nr-PhysCellID.

In some examples, the IE NR-DL-PRS-ExpectedLOS-NLOS-Assistance may include an nr-los-nlos-indicator field that provides the expected likelihood of a LOS propagation path from a TRP to the target device (e.g., choice perTrp) or for all DL-PRS resources of the TRP (e.g., choice perResource). In accordance with some aspects, the example IEs in FIGS. 8A-9 may be used to support and/or be modified to support the techniques for measurement and reporting of CTIs and PTIs associated with RF sensing operations described herein.

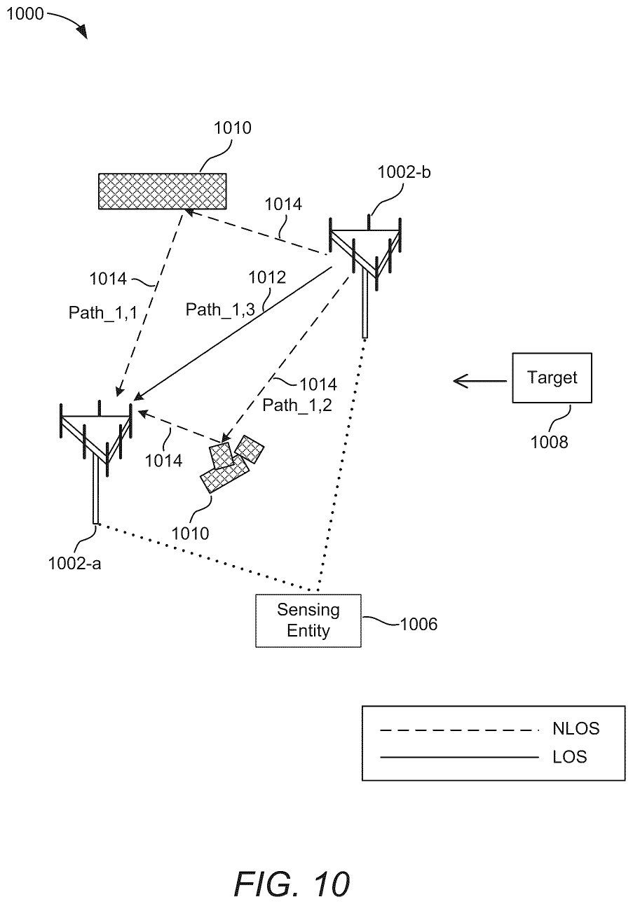

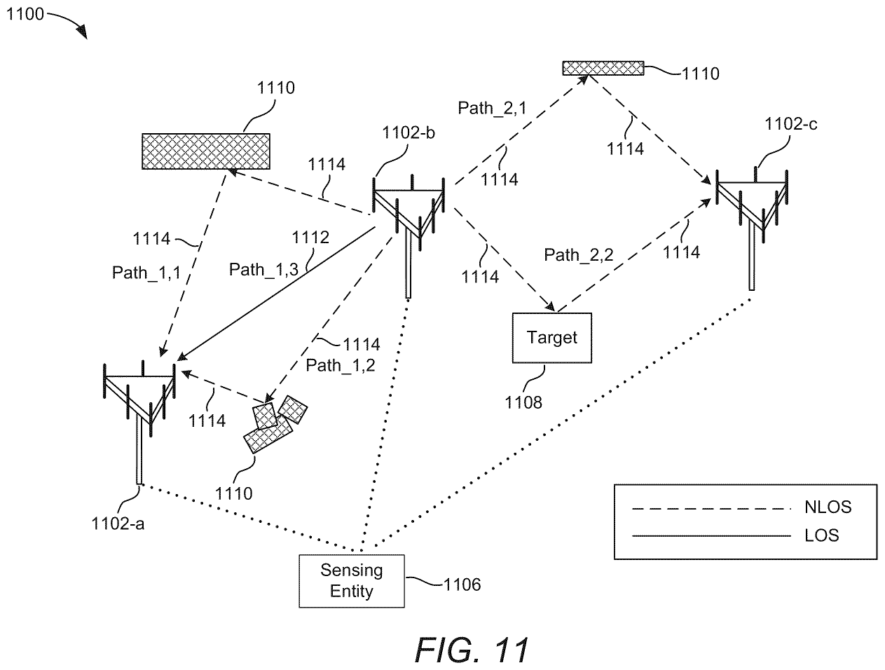

FIG. 10 illustrates a first example wireless communications system 1000 that supports measurement and reporting techniques for CTIs and PTIs for sensing operations, according to aspects of the disclosure. In certain aspects, wireless communications system 1000 is an example of, or includes aspects of, the corresponding elements and/or features described with reference to FIGS. 1-9. In some examples, wireless communications system 1000 may include TRPs 1002, sensing entity 1006, target 1008, non-target objects 1010, LOS path 1012, and NLOS paths 1014.

In some examples, a first TRP 1002-a may be configured as a first sensing node. In some cases, the first TRP 1002-a may be the receiving sensing node for a sensing session. The first TRP 1002-a may obtain measurements of one or more paths received from a second TRP 1002-b. The second TRP 1002-b may be configured as a transmitting sensing node for the sensing session. In some examples, the one or more paths, such as LOS path 1012 and NLOS paths 1014 may be received by the first TRP 1002-a. In some cases, the NLOS paths 1014 may be reflected paths from non-target objects 1010, which may constitute clutter reflections, in accordance with some aspects. In some non-limiting examples, the non-target objects 1010 may represent boxes or factory structures as obstacles or clutter objects that are different from a target 1008.

In some examples, the one or more paths received by the first TRP 1002-a may be from one or more first sensing reference signals transmitted by the second TRP 1002-b. The one or more first sensing reference signals may be associated with and/or transmitted over a first wireless channel. That is, for example, the one or more paths may include a Path_1,1 referencing a first wireless channel and a first path of the first wireless channel as an NLOS path 1014; a Path_1,2 referencing the first wireless channel and a second path of the first wireless channel as an NLOS path 1014; and a Path_1,3 referencing the first wireless channel and a third path of the first wireless channel as an LOS path 1012.

In some examples, the first TRP 1002-a may transmit, to a sensing entity 1006, a first measurement report that includes a first CTI associated with the first wireless channel. In some cases, the first CTI may indicate that the first wireless channel is estimated to include reflections from the target 1008 or that the first wireless channel is estimated to include clutter reflections from the non-target objects 1010 absent target reflections.

In some examples, the first TRP 1002-a may transmit the CTI expressed as a hard value or a soft value. For example, when expressed as a hard value, the first TRP 1002-a may transmit the CTI to indicate ‘FALSE’ indicating a likelihood of ‘0’, or ‘TRUE’ indicating a likelihood of ‘1’. That is, the CTI may specify whether the first wireless channel (e.g., including the three paths, Path_1,1, Path_1,2, and Path_1,3) between the second TRP 1002-b and the first TRP 1002-a is estimated to include the target 1008 (e.g., ‘TRUE’) or not to include the target 1008 (e.g., ‘FALSE’). In some examples, when expressed as a soft value, the first TRP 1002-a may transmit the CTI to provide information on the likelihood of the target 1008 being in the first wireless channel according to a scale. That is, for example, an integer value ‘0’ may correspond to a low likelihood that the target 1008 is in the first wireless channel, and integer value ‘1’ may correspond to a high likelihood that the target 1008 is in the first wireless channel. The scale factor of the soft value may include 0.1 increments within the range from 0 to 1.

In some examples, the sensing entity 1006 (e.g., a sensing server, such as an LMF or a sensing management function (SnMF), a gNB, a roadside unit (RSU), etc.) may be operatively coupled with the first TRP 1002-a and the second TRP 1002-b. The sensing entity 1006 may coordinate the sensing session with the first TRP 1002-a and the second TRP 1002-b as well as analyze the corresponding sensing results. It is to be understood that the sensing entity 1006 may be a core network entity that is responsible for managing and coordinating sensing sessions or a standalone entity outside of the core network entity, in accordance with various implementations.

For example, one or both of the first TRP 1002-a and the second TRP 1002-b may be configured by the sensing entity 1006 to provide detection of one or more channel targets, in a set of channels. For example, a target sensing configuration may include the set of channels of interest and one or more reference signals to use for a corresponding channel. That is, for example, the first TRP 1002-a may be configured to monitor a first wireless channel that includes one or more first sensing reference signals from the second TRP 1002-b. The first TRP 1002-a may also be configured to monitor the first wireless channel that includes one or more second sensing reference signals also from the second TRP 1002-b or from another TPR different from the second TRP 1002-b. In some cases, the one or more first sensing reference signals from the second TRP 1002-b may correspond to signal transmissions within a first frequency range and the one or more second sensing reference signals from the second TRP 1002-b may correspond to signal transmissions within a second frequency range different from the first frequency range.

Additionally, or alternatively, the first TRP 1002-a may be configured to monitor a first wireless channel that includes one or more first sensing reference signals from the second TRP 1002-b and a second channel that includes one or more second sensing reference signals from another TPR different from the second TRP 1002-b. In some cases, the one or more first sensing reference signals from the second TRP 1002-b may correspond to signal transmissions within a same frequency range as the one or more second sensing reference signals from the other TPR different from the second TRP 1002-b.

In some examples, to estimate a CTI, the first TRP 1002-a may first determine a reference state of the first wireless channel and may then compare a measured state of the first wireless channel with the reference state. That is, for example, the sensing entity 1006 may be aware that the target 1008 may be moving or expected to be moving in the direction of the first wireless channel. The sensing entity 1006 may configure the first TRP 1002-a and the second TRP 1002-b such that the first TRP 1002-a obtains initial measurements of one or more paths of one or more sensing reference signals during a first time period. The first TRP 1002-a may be aware that no target is present during the first time period. For example, the initial measurements constituting the reference state of the first wireless channel may be determined to be the NLOS path 1014 of Path_1,1, the NLOS path 1014 of Path_1,2, and the LOS path 1012 of Path_1,3.

In some cases, the first time period may include multiple sensing sessions such that the first TRP 1002-a obtains multiple initial measurements of one or more paths of one or more sensing reference signals during the first time period. The first TRP 1002-a may average the multiple initial measurements (e.g., averaging several past observations). In this manner, the first TRP 1002-a may obtain the reference state of the first wireless channel.

In some examples, the measured state may be determined by the first TRP 1002-a during a second time period different from the first time period. That is, for example, the first TRP 1002-a may obtain measurements of one or more paths of the one or more sensing reference signals associated with the second TRP 1002-b over the first wireless channel during the second time period. The second time period may be considered as a time period during which the real time sensing operations are performed. The first TRP 1002-a may compare the newly measured first wireless channel with the reference state of the first wireless channel that the first TRP 1002-a has saved. The first TRP 1002-a may then determine whether a significant change in the condition of the first wireless channel has occurred due to the presence of one or more targets.

In some cases, the significant change in the condition of the first wireless channel may include new or additional paths detected in the first wireless channel reflected from a target. In some cases, the significant change in the condition of the first wireless channel may include the absence of a prior path (e.g., a target occluding the LOS path 1012 of Path_1,3). In this manner, the clutter characteristics of the first wireless channel may be ascertained so the clutter reflections from the non-target objects 1010 are less likely to be misidentified as reflections from a target.

For example, if the target 1008 travels proximate to the coverage area associated with the first wireless channel between the first TRP 1002-a and the second TRP 1002-b the during the second time period, the first TRP 1002-a may determine that the reflections therefrom are associated with the target 1008 based at least in part on the reference state of the first wireless channel not including such reflections.

Additionally, or alternatively, the first TRP 1002-a estimate the Doppler profile of the paths in the first wireless channel. For example, the non-target objects 1010 may be stationary or at least relatively stationary. Accordingly, if the maximum detected Doppler profile associated with the one or more paths is not zero, the first TRP 1002-a may determine that a moving target is present in the first wireless channel.

Various techniques may be used by a sensing node (e.g., the first TRP 1002-a configured as a sensing node) to determine whether a target is likely present in a channel and to generate a CTI indicating the determination. For example, the determination whether a target is likely present in a channel may be implementation based such that the first TRP 1002-a includes certain processing and filtering techniques to make such a determination. In some cases, these processing and filtering techniques may be proprietary to the sensing node vendor. In some examples, at least some of the processing steps for determining whether a target is likely present in a channel may be specified by a standards organization (e.g., in a 3GPP technical standard).

In some examples, at least some of the processing steps and/or techniques for determining whether a target is likely present in a channel may be specified by the sensing entity 1006. That is, for example, sensing entity 1006 may provide information (e.g., assistance data) to the first TRP 1002-a regarding how to compute a value for a CTI. The information provided by the sensing entity 1006 may include a neural network (NN) model that the first TRP 1002-a uses to estimate the CTI. In some examples, the first TRP 1002-a may retrieve the NN model based at least in part on a model ID provided by the sensing entity 1006. The first TRP 1002-a may use the retrieved NN model to estimate a value for the CTI. In some cases, the NN model can be retrieved from the sensing entity 1006 or from a model repository entity in the core network (e.g., core network 170) or accessible therefrom.

In some examples, the first TRP 1002-a may perform the NN model associated with the CTI using assistance data provided by the sensing entity 1006 and/or other entities in the core network (e.g., a model repository entity in the core network 170). In some cases, the assistance data may include the reference state of the channel (e.g., channel conditions with no target present).

As illustrated in the example of FIG. 10, each of the sensing nodes is a TRP 1002. However, one or more of the sensing nodes (e.g., receiving sensing nodes or transmitting sensing nodes) may be a UE (e.g., UE 104, UE 304, etc.) as described herein. In some cases, the first TRP 1002-a may be configured as a transmitting node for a sensing session, and the first TRP 1002-a may obtain measurements of the one or more paths received from the second TRP 1002-b that performs at least some measurements and sends those measurements to the first TRP 1002-a (e.g., in a sensing session involving bistatic sensing operations).

FIG. 11 illustrates a second example wireless communications system 1100 that supports measurement and reporting techniques for CTIs and PTIs for sensing operations, according to aspects of the disclosure. In certain aspects, wireless communications system 1100 is an example of, or includes aspects of, the corresponding elements and/or features described with reference to FIGS. 1-10. In some examples, wireless communications system 1100 may include TRPs 1102, sensing entity 1106, target 1108, non-target objects 1110, LOS path 1112, and NLOS paths 1114.

In some examples, a first TRP 1102-a may be configured as a first sensing node, a second TRP 1102-b may be configured as a second sensing node, and a third TRP 1102-c may be configured as a third sensing node. In some cases, the first TRP 1102-a and the third TRP 1102-c may be configured as the receiving sensing nodes for one or more sensing session. The first TRP 1102-a and the third TRP 1102-c may obtain measurements of one or more paths received from the second TRP 1102-b. The second TRP 1102-b may be configured as the transmitting sensing node for the one or more sensing sessions. In some examples, the one or more paths, such as LOS path 1112 and NLOS paths 1114 may be received by first TRP 1102-a and the third TRP 1102-c. In some cases, the NLOS paths 1114 may be reflected paths from non-target objects 1110, which may constitute clutter reflections, in accordance with some aspects. In some non-limiting example, the non-target objects 1110 may represent boxes or factory structures as obstacles or clutter objects that are different from a target 1108.

In some examples, the one or more paths received by the first TRP 1102-a may be from one or more first sensing reference signals transmitted by the second TRP 1102-b, and the one or more paths received by the third TRP 1102-c may be from one or more second sensing reference signals transmitted by the second TRP 1102-b. The one or more first sensing reference signals may be associated with and/or transmitted over a first wireless channel, and the one or more first sensing reference signals may be associated with and/or transmitted over a second wireless channel.

That is, for example, the one or more paths over the first wireless channel may include a Path_1,1 referencing first wireless channel and a first path of the first wireless channel as an NLOS path 1114; a Path_1,2 referencing the first wireless channel and a second path of the first wireless channel as an NLOS path 1114; and a Path_1,3 referencing the first wireless channel and a third path of the first wireless channel as an LOS path 1112. The one or more paths over the second wireless channel may include a Path_2,1 referencing second wireless channel and a first path of the second wireless channel as an NLOS path 1114 and a Path_2,2 referencing the second wireless channel and a second path of the second wireless channel as an NLOS path 1114 reflected from the target 1108. In some cases, the target 1108 may be an AGV that is being tracked by the sensing entity 1106.

For example, each of the TRPs 1102 may indicate to the sensing entity 1106 (e.g., via capability information in an IE or field of an IE) whether the TRP 1102 supports reporting CTIs, and if so, whether a hard value or hard and soft values are supported for reporting CTIs (e.g., a supported granularity). The first TRP 1102-a and the third TRP 1102-c may indicate to the sensing entity 1106 that each of the first TRP 1102-a and the third TRP 1102-c supports hard and soft values for reporting CTIs. The first TRP 1102-a may transmit, to the sensing entity 1106, a first measurement report that includes a first CTI for first wireless channel as a hard value estimating that the first channel does not include the target 1108 (e.g., a hard value of ‘FALSE’). Additionally, the third TRP 1102-c may transmit, to the sensing entity 1106, a second measurement report that includes a second CTI for the second wireless channel as a soft value estimating that the first channel likely includes the target 1108 (e.g., a soft value of 0.8 or 80%). For example, the soft value determined by the third TRP 1102-c may be based on a Doppler profile of the target 1108 as a slow moving AGV derived from the NLOS path 1114 of Path_2,2.

In accordance with some aspects, the reported CTIs may be used by the sensing entity 1106 as an initial step in detecting the target 1108 to be tracked. That is, for example, the CTI generation and reporting phase may be considered a scanning phase for detection of the target. Consequently, the associated sensing reference signal resources may be allocated, and the sensing reference signals may be transmitted in accordance with the goal of this scanning phase. Then, based at least in part on the channels that detect the presence of a target and the associated probabilities (e.g., the second channel indicating detection of the target 1108 with an 80% probability), the sensing entity 1106 may use a more refined or granular tracking phase in certain coverage areas associated with the various channels. For example, a first step CTI generation and reporting may be performed using one frequency range (e.g., FR1) better suited for initial detection of a target. In some cases, a second step CTI generation and reporting (or a subsequent tracking phase) may be performed using another frequency range (e.g., FR2) better suited for more accurate positioning determination of the target.

Various CTI reporting constructs related to granularity and network configurations are contemplated. For example, a CTI may be reported on a per sensing node basis. That is, for example, a CTI may be associated with a particular sensing node. In some case, the transmitting sensing node (e.g., the second TRP 1102-b) may be the particular sensing node associated with CTI reporting. In some cases, the CTI may be determined using one or multiple sensing reference signal resources or sensing reference signal resource sets from the second TRP 1102-b acting as a transmitter. In some examples, a CTI may be reported on a per sensing reference signal resource or per sensing reference signal resource set basis. That is, for example, a corresponding CTI may be associated with and indicated for each sensing reference signal resource, or each sensing reference signal resource set corresponding of the transmitting sensing node (e.g., the second TRP 1102-b).

For example, the second wireless channel may include the NLOS path 1114 of Path_2,1 and the NLOS path 1114 of Path_2.2. The second wireless channel may be configured with a first DL-PRS Resource Set ID and a second DL-PRS Resource Set ID that contribute to the detection of these paths. The second wireless channel may be configured to include a first CTI and a second CTI for reporting on a per sensing reference signal resource set basis. For example, the first CTI may be associated with the first DL-PRS Resource Set ID that results in the NLOS path 1114 of Path_2.1. The second CTI may be associated with the second DL-PRS Resource Set ID that results in the NLOS path 1114 of Path_2,2 that is determined to be reflected from the target 1108. If hard values are indicated for these CTIs, the first CTI for the second wireless channel may be estimated as not including the target 1108 (e.g., a hard value of ‘FALSE’) and the second CTI for the second wireless channel may be estimated as including the target 1108 (e.g., a hard value of ‘TRUE’).

In some examples, multiple granularities or layers may be employed by the sensing entity 1106 including one or more CTIs determined on a per sensing reference signal resource set basis and a CTI determined on a per sensing node basis. For example, a third CTI may be configured per sensing node basis for the transmitting sensing node (e.g., the second TRP 1102-b). The third CTI may be configured to report on multiple wireless channels of the second TRP 1102-b, for example, the first wireless channel and the second wireless channel. If a hard value is indicated for the third CTIs, the third CTI for the second TRP 1102-b may be estimated as including the target 1108 (e.g., a hard value of ‘TRUE’).

It is to be understood that based on a sensing node type (e.g., a TRP 1102, a UE, another NG-RAN node, etc.) and the sensing entity type (e.g., a sensing entity 1106, a sensing server, TRP 1102, another network core entity or NG-RAN node, etc.), the configuration and/or assistance data associated with CTI generation and reporting may be signaled by various means, including but not limited to the following signaling: LPP (or equivalent), NRPPa, RRC. MAC control element (CE), downlink control information (DCI), SLPP (sidelink LPP), sidelink (SL) RRC, SL MAC CE, sidelink control information (SCI) stage 1, or SCI stage 2.

Although a CTI may indicate a presence of the target 1108, a sensing node (e.g., the second TRP 1102-b configured as the transmitting sensing node) may not be aware of or determine new or additional paths that originated from or are associated with the target 1108. Additionally, or alternatively, a PTI may be reported for each additional path determined by the one or more sensing nodes during one or more sensing sessions. For example, when reporting the one or more CTI, one or more sensing node may report whether any additionally detected paths correspond to a path that includes a reflection from the target 1108 or a path that includes a clutter reflection from a non-target object 1110 absent a target reflection. That is, for example, when performing sensing operations (e.g., during the determination of either a reference state of a channel or a measured state of a channel, or during the measured state of the channel after the reference state has been established), each additional path determined may include a corresponding PTI.

A sensing node (e.g., the first TRP 1102-a configured as a receiving sensing node) may determine a reflection order of each path. That is, a reflection order may describe how many reflections the path went through while propagating from the transmitting sensing node to the receiving sensing node. In some cases, the reflection order may be also reported along with the path. For example, when determining the reference state of the first channel (e.g., including the three paths, Path_1,1, Path_1,2, and Path_1,3), the first TRP 1102-a may report (e.g., using hard values): a first PTI for the NLOS path 1114 of Path_1,1 as not to include the target 1108 (e.g., ‘FALSE’) and to have a reflection order of one; a second PTI for the NLOS path 1114 of Path_1,2 as not to include the target 1108 (e.g., ‘FALSE’) and to have a reflection order of one; and a third PTI for the LOS path 1112 of Path_1,3 as not to include the target 1108 (e.g., ‘FALSE’) and to have a zero reflection order.

As illustrated in the example of FIG. 11, each of the sensing nodes is a TRP 1102. However, one or more of the sensing nodes (e.g., receiving sensing nodes or transmitting sensing nodes) may be a UE (e.g., UE 104, UE 304, etc.) as described herein. In some cases, the first TRP 1102-a and the third TRP 1102-c may be configured as a transmitting node for a sensing session, and the first TRP 1102-a and the third TRP 1102-c may obtain measurements of the one or more paths received from the second TRP 1102-b that performs at least some measurements and sends those measurements to the first TRP 1002-a and the third TRP 1102-c (e.g., in a sensing session involving bistatic sensing operations).

For example, when UE-based RF sensing operations are performed in the wireless communications system 1100, the sensing entity 1106 may provide assistance data of the CTI to one or more UEs. In some examples, a UE may use the information in the assistance data to optimize the scheduling of a sensing session. In some cases, the information may be requested from the sensing entity 1106 by the UE. The assistance data from the sensing entity 1106 may include an IE corresponding to the expectation of a CTI for the one or more wireless channels associated with UE as the sensing node.

In a non-limiting example, an IE corresponding to the expectation of a CTI (e.g., NR-ExpectedChannelTargetIndicator or the like) may be used by the sensing entity 1106 to provide the expected likelihood of a target being present in one or more propagation paths of a wireless channels between the UE and one or more transmitting sensing nodes (e.g., the second TRP 1102-c). The IE corresponding to the expectation of a CTI may be constructed in a similar manner to the example of an LOS-NLOS assistance data IE 900 in the example of FIG. 9. In some cases, the IE corresponding to the expectation of a CTI may include a field that provides an indication of the DL-PRS resources for which there is the expected likelihood of a target being present in one or more propagation paths of one or more wireless channels between the UE and one or more transmitting sensing nodes.

Additionally, or alternatively, when additional paths are determined during a sensing operation, for example, during the procedure for determining a CTI or other sensing operations not involving CTIs. The additional paths may be reported back to the sensing entity 1106. For example, in the context of NR positioning, the reporting of additional paths by a positioning target device may be supported in some network scenarios. That is, for example, the positioning target device may report additional NLOS paths detected in addition to a main LOS path. In some cases, the positioning target device may also report the additional NLOS path receive power and the path's relative time delay (RTD) with respect to the main LOS path from the same TRP used for a positioning measurement. That is, for example, when reporting additional paths to the sensing entity 1106, the third TRP 1102-c may additionally report a PTI indicating whether the additional path is estimated to have originated from the target 1108 in the wireless communications system 1100 or from clutter objects that are different from the target 1108 in the wireless communications system 1100. In some examples, the determination of the PTI indicating whether the additional path is estimated to have originated from the target 1108 or from clutter objects may be performed by implementation at the third TRP 1102-c or using configuration from the sensing entity 1106 similar to the examples in the determination of the CTI.

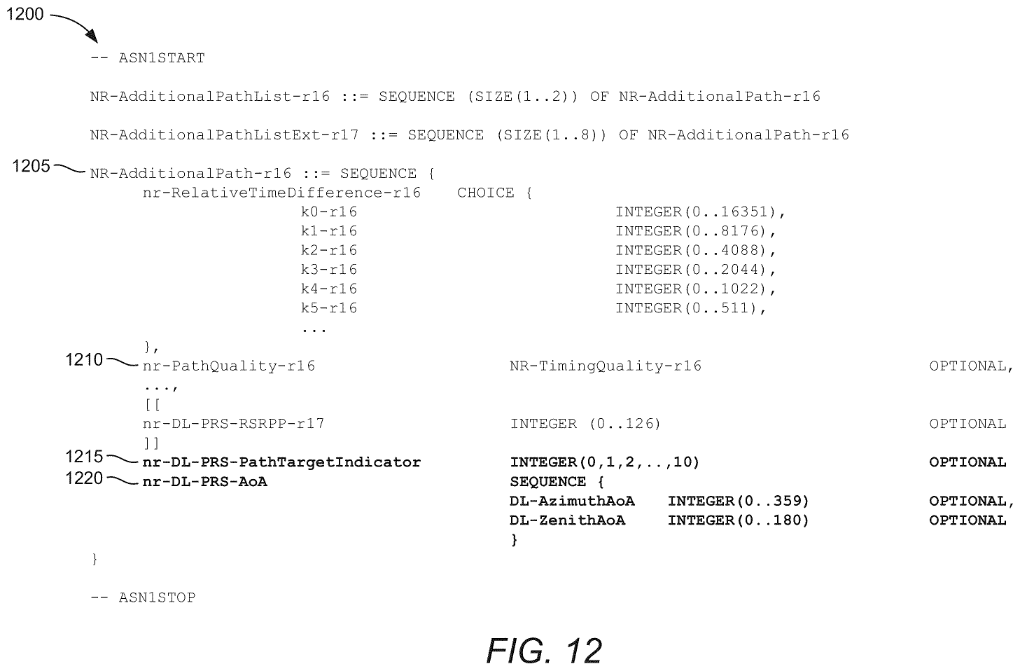

FIG. 12 illustrates an example of an additional path indicator IE 1200, according to aspects of the disclosure. The example additional path indicator IE 1200 in the example of FIG. 9 may be a version of the IE NR-AdditionalPathList which may be used by a target device to provide information about additional paths in association to the TOA measurements associated to NR positioning. The NR positioning for the IE NR-AdditionalPathList may be presented in the form of a relative time difference and a quality value. In some cases, the IE NR-AdditionalPathList may be provided with respect to different positioning techniques, such as NR DL TDOA measurements and NR RTT measurements. In some cases, the additional path indicator IE 1200 may be used by a sensing node for reporting sensing operations as described herein.

For example, the additional path indicator IE 1200 may include some of the ASN1 (Abstract Syntax Notation One) language used to describe data structures in the example of FIG. 12. Additionally, or alternatively, the additional path indicator IE 1200 may use other notations or languages to describe these data structures. In some examples, each additional path may be expressed in the NR-AdditionalPath IE 1205 that may include information related to one or more additional detected paths, such as the nr-RelativeTimeDifference, which is the detected path timing relative to the detected path timing used for the TOA value. That is, for example, each additional path may include fields specifying one or more additional detected path timing values for a TRP or resource, relative to the path timing used for determining the nr-RSTD value.

In some cases, each additional path may be associated with a quality value nr-PathQuality field 1210. That is, for example, the field in nr-PathQuality field 1210 may specify a target device or sensing node's estimate of the quality of the detected timing of the additional path. In some cases, each additional path may include an indication specifying the DL PRS reference signal received path power (DL PRS-RSRPP) of the additional path reported.

In some cases, each additional path may also include an indication associated with whether the additional path is estimated to be that of a target. That is, for example, an nr-DL-PRS-PathTargetIndicator field 1215 may include a soft indication (e.g., INTEGER (0, 1, 2, . . . 10) indicating the likelihood that the additional path is that of the target. That is, for example, an integer value ‘O’ indicates a likelihood of 0 (e.g., low likelihood) that the additional path is estimated to be that of the target, and an integer value ‘10’ indicates a likelihood of 1 (e.g., high likelihood) that the additional path is estimated to be that of the target. In some cases, the scale factor of the soft value may include 0.1 increments within the range from 0 to 1. In some cases, this the nr-DL-PRS-PathTargetIndicator field 1215 may be an optional field.

In some cases (not shown in FIG. 12), the nr-DL-PRS-PathTargetIndicator field may include a hard indication. That is, for example, the nr-DL-PRS-PathTargetIndicator field may specify whether the additional path is estimated to be that of the target (e.g., ‘TRUE’) or the additional path is estimated not to be that of the target (e.g., ‘FALSE’). In some cases (not shown in FIG. 12), the nr-DL-PRS-PathTargetIndicator field 1215 may be a mandatory field.

In some cases, for example, when the additional path is estimated as at least possibly or likely to be a target (e.g., 10% likely or greater, 50% likely or greater, etc.), the additional path may report a detected AoA. That is, for example, an nr-DL-PRS-AoA field 1220 may specify the measured AoA in the Global Coordinate System (GCS) of the additional path estimated to be the target. That is, for example, the nr-DL-PRS-AoA field 1220 may include a DL-AzimuthAoA field, which specifies the measured azimuth angle of arrival. In some cases, the scale factor of the DL-AzimuthAoA field may be 1 degree within a range 0 to 359 degrees. In some examples, the nr-DL-PRS-AoA field 1220 may also include a DL-ZenithAoA field, which specifies the measured elevation angle of arrival. In some cases, the scale factor of the DL-ZenithAoA field may be 1 degree within a range 0 to 180 degrees.

It is to be appreciated that other ways to express a PTI and the measured AoA as a field, IE, or the like are contemplated as would be understood given the benefit of the non-limiting example IE and fields in FIG. 12 and the disclosure as a whole.

Referring back to FIG. 11, for example, each of the TRPs 1102 may indicate to the sensing entity 1106 (e.g., via capability information in an IE or field) whether the TRP 1102 supports reporting PTIs, and if so, whether a hard value or hard and soft values are supported for reporting PTIs (e.g., a supported granularity). The first TRP 1102-a and the third TRP 1102-c may indicate to the sensing entity 1106 that they each support hard and soft values for reporting CTIs. In some cases, the capability information related to sensing node support of CTIs and/or PTIs may be solicited from the sensing entity 1106 (e.g., responsive to a capabilities request from the sensing entity 1106), or unsolicited (e.g., a capabilities report sent from the TRPs 1102 to the sensing entity 1106 absent a request).

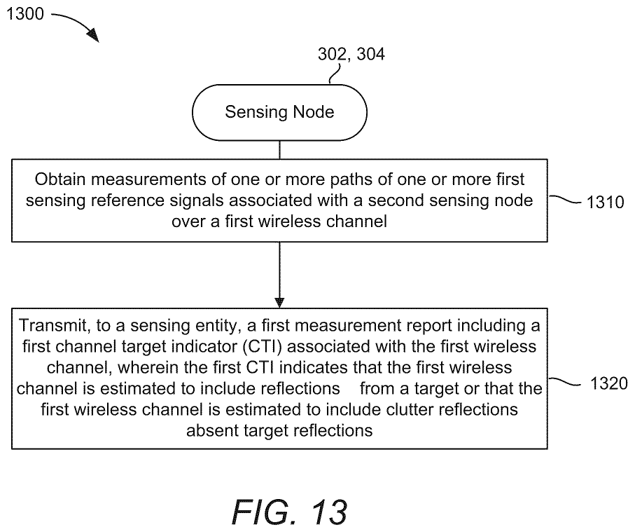

FIG. 13 is a flowchart of an example process 1300 related to techniques for measurement and reporting of CTIs associated with RF sensing operations, according to aspects of the disclosure. In some implementations, one or more process blocks of FIG. 13 may be performed by a first sensing node (e.g., a base station 302, a UE 304, etc.). In some implementations, one or more process blocks of FIG. 13 may be performed by another device or a group of devices separate from or including the first sensing node. Additionally, or alternatively, one or more process blocks of FIG. 13 may be performed by one or more components of an apparatus, such as a processor(s), memory, or transceiver(s), any or all of which may be means for performing the operations of process 1300.

As shown in FIG. 13, process 1300 may include, at block 1310, obtaining measurements of one or more paths of one or more first sensing reference signals associated with a second sensing node over a first wireless channel. Means for performing the operation of block 1310 may include the processor(s), memory, or transceiver(s) of any of the apparatuses described herein. For example, the first sensing node may obtain measurements of one or more paths of one or more first sensing reference signals associated with a second sensing node over a first wireless channel, using transceivers 310, 320, or transceivers 350, 360.

As further shown in FIG. 13, process 1300 may include, at block 1320, transmitting, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections. Means for performing the operation of block 1320 may include the processor(s), memory, or transceiver(s) of any of the apparatuses described herein. For example, the first sensing node may transmit, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections, using transceivers 310, 320, or transceivers 350, 360.

Process 1300 may include additional implementations, such as any single implementation or any combination of implementations described below and/or in connection with one or more other processes described elsewhere herein.

In some aspects, process 1300 includes obtaining initial measurements of the one or more paths of the one or more first sensing reference signals during a first time period to obtain a reference state of the first wireless channel, and determining that the first wireless channel is estimated to include reflections from the target based at least in part on a comparison of a measured state and the reference state, wherein the first CTI indicates that the first wireless channel is estimated to include reflections from the target based at least in part on the determining, and the measured state is based at least in part on the obtaining measurements of one or more paths of one or more first sensing reference signals associated with the second sensing node over the first wireless channel during a second time period different from the first time period.

In some aspects, process 1300 includes estimating a Doppler profile for each of the one or more paths, and determining that the first wireless channel is estimated to include reflections from the target based at least in part on the estimating the Doppler profile for each of the one or more paths, wherein the first CTI indicates that the first wireless channel is estimated to include reflections from the target based at least in part on the determining.

In some aspects, process 1300 includes determining that the target is estimated to be moving based at least in part on the estimating the Doppler profile for each of the one or more paths, wherein the first measurement report includes information indicating that the target is estimated to be moving.

In some aspects, process 1300 includes receiving, from the sensing entity, a sensing configuration that includes first information and second information, wherein the first information indicates that a first reference signal set including the one or more first sensing reference signals is associated with the second sensing node, and the second information indicates that a second reference signal set including one or more second sensing reference signals is associated with a third sensing node different from the second sensing node.

In some aspects, process 1300 includes obtaining measurements of one or more paths of the one or more second sensing reference signals associated with the third sensing node over a second wireless channel different from the first wireless channel, wherein the first measurement report includes a second CTI associated with the second wireless channel.

In some aspects, the second CTI indicates that the second wireless channel is estimated to include reflections from the target or another target different from the target, or that the second wireless channel is estimated to include clutter reflections absent target reflections.

In some aspects, process 1300 includes receiving, from the sensing entity, an indication of a neural network model for estimating the first CTI, obtaining the neural network model based at least in part on the received identification, and receiving assistance data associated with the neural network model.

In some aspects, the assistance data associated with the neural network model comprises information corresponding to a reference state of the first wireless channel.

In some aspects, process 1300 includes obtaining measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target, and transmitting, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

In some aspects, the one or more second sensing reference signals are associated with a second frequency range different from a first frequency range of the one or more first sensing reference signals.

In some aspects, process 1300 includes determining that at least one additional path is associated with the target based at least in part on the measurements of the one or more paths of the one or more first sensing reference signals, wherein the first measurement report includes information indicating the at least one additional path.

In some aspects, process 1300 includes determining a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

In some aspects, the CTI is expressed as a hard value or a soft value.

In some aspects, the first sensing node is a user equipment (UE) or a transmission-reception point (TRP).

In some aspects, the first sensing node is a transmitting sensing node or a receiving sensing node.

In some aspects, the sensing entity is a sensing server or a next generation radio access network (NG-RAN) node.

Although FIG. 13 shows example blocks of process 1300, in some implementations, process 1300 may include additional blocks, fewer blocks, different blocks, or differently arranged blocks than those depicted in FIG. 13. Additionally, or alternatively, two or more of the blocks of process 1300 may be performed in parallel.

As will be appreciated, a technical advantage of the process 1300 is that by indicating a CTI, the sensing server can obtain location information of a target to efficiently detect and track the target. That is, for example, one or more CTIs reported by the sensing nodes to the sensing server enables efficient scanning and tracking phases to be performed.

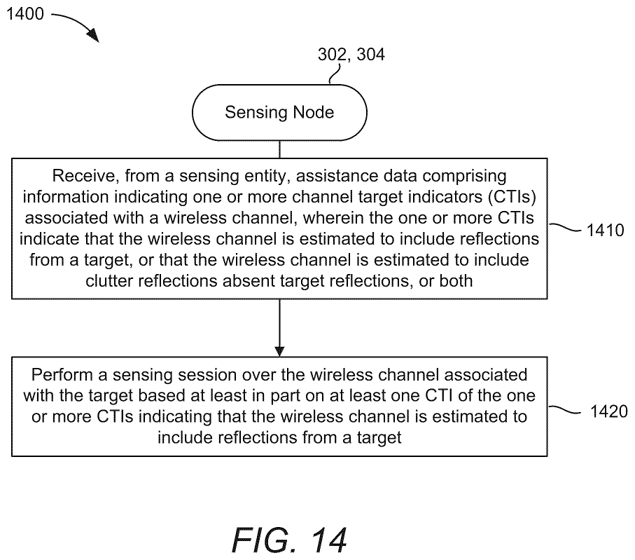

FIG. 14 is a flowchart of an example process 1400 related to techniques for measurement and reporting of CTIs associated with RF sensing operations, according to aspects of the disclosure. In some implementations, one or more process blocks of FIG. 14 may be performed by a first sensing node (e.g., a base station 302, a UE 304, etc.). In some implementations, one or more process blocks of FIG. 14 may be performed by another device or a group of devices separate from or including the first sensing node. Additionally, or alternatively, one or more process blocks of FIG. 14 may be performed by one or more components of an apparatus, such as a processor(s), memory, or transceiver(s), any or all of which may be means for performing the operations of process 1400.

As shown in FIG. 14, process 1400 may include, at block 1410, receiving, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both. Means for performing the operation of block 1410 may include the processor(s), memory, or transceiver(s) of any of the apparatuses described herein. For example, the first sensing node may receive, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both, using transceivers 310, 320, or transceivers 350, 360.

As further shown in FIG. 14, process 1400 may include, at block 1420, performing a sensing session over the wireless channel associated with the target based at least in part on at least one CTI of the one or more CTIs indicating that the wireless channel is estimated to include reflections from a target. Means for performing the operation of block 1420 may include the processor(s), memory, or transceiver(s) of any of the apparatuses described herein. For example, the first sensing node may perform a sensing session over the wireless channel associated with the target based at least in part on at least one CTI of the one or more CTIs indicating that the wireless channel is estimated to include reflections from a target, using transceivers 310, 320, or transceivers 350, 360.

Process 1400 may include additional implementations, such as any single implementation or any combination of implementations described below and/or in connection with one or more other processes described elsewhere herein.

In some aspects, process 1400 includes transmitting, to the sensing entity, a request for the one or more CTIs associated with the wireless channel, wherein the assistance data is received responsive to the request.

In some aspects, the information indicating one or more CTIs associated with the wireless channel comprises an information element corresponding to an expected likelihood of the target in a propagation path of the wireless channel from a transmission-reception point (TRP) to the first sensing node.

In some aspects, process 1400 includes transmitting, to the sensing entity, a capability report of the first sensing node comprising an indication of support for CTIs, wherein the capability report of the first sensing node comprises an indicated type and granularity supported for the CTIs.

In some aspects, process 1400 includes receiving, from the sensing entity, a request for a capability indication associated with the support for CTIs, wherein the capability report is transmitted responsive to the request.

In some aspects, the first sensing node is a user equipment (UE) and a transmitting sensing node.

Although FIG. 14 shows example blocks of process 1400, in some implementations, process 1400 may include additional blocks, fewer blocks, different blocks, or differently arranged blocks than those depicted in FIG. 14. Additionally, or alternatively, two or more of the blocks of process 1400 may be performed in parallel.

As will be appreciated, a technical advantage of the process 1400 is that by receiving assistance data from a sensing server that includes information indicating CTIs, a sensing node may perform efficient sensing sessions over wireless channels that are likely to include a target.

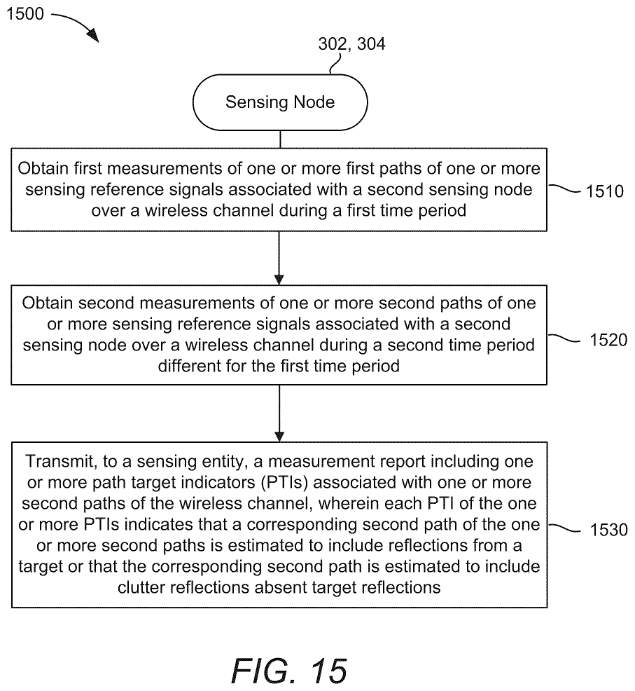

FIG. 15 is a flowchart of an example process 1500 related to techniques for measurement and reporting of PTIs associated with RF sensing operations according to aspects of the disclosure. In some implementations, one or more process blocks of FIG. 15 may be performed by a first sensing node (e.g., a base station 302, a UE 304, etc.). In some implementations, one or more process blocks of FIG. 15 may be performed by another device or a group of devices separate from or including the first sensing node. Additionally, or alternatively, one or more process blocks of FIG. 15 may be performed by one or more components of an apparatus, such as a processor(s), memory, or transceiver(s), any or all of which may be means for performing the operations of process 1500.

As shown in FIG. 15, process 1500 may include, at block 1510, obtaining first measurements of one or more first paths of one or more sensing reference signals associated with a second sensing node over a wireless channel during a first time period. Means for performing the operation of block 1510 may include the processor(s), memory, or transceiver(s) of any of the apparatuses described herein. For example, the first sensing node may obtain first measurements of one or more first paths of one or more sensing reference signals associated with a second sensing node over a wireless channel during a first time period, using transceivers 310, 320, or transceivers 350, 360.

As further shown in FIG. 15, process 1500 may include, at block 1520, obtaining second measurements of one or more second paths of one or more sensing reference signals associated with a second sensing node over a wireless channel during a second time period different for the first time period. Means for performing the operation of block 1520 may include the processor(s), memory, or transceiver(s) of any of the apparatuses described herein. For example, the first sensing node may obtain second measurements of one or more second paths of one or more sensing reference signals associated with a second sensing node over a wireless channel during a second time period different for the first time period, using transceivers 310, 320, or transceivers 350, 360.

As further shown in FIG. 15, process 1500 may include, at block 1530, transmitting, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections. Means for performing the operation of block 1530 may include the processor(s), memory, or transceiver(s) of any of the apparatuses described herein. For example, the first sensing node may transmit, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections, using transceivers 310, 320, or transceivers 350, 360.

Process 1500 may include additional implementations, such as any single implementation or any combination of implementations described below and/or in connection with one or more other processes described elsewhere herein.

In some aspects, process 1500 includes determining one or more additional paths for the wireless channel based at least in part on the obtaining the second measurements, wherein each PTI of the one or more PTIs corresponds to each additional path of the one or more additional paths.

In some aspects, process 1500 includes each PTI of the one or more PTIs is indicated in a PTI field of an additional path information element, and the additional path information element includes a first field specifying a reference signal received path power and a second field specifying an angle of arrival for each additional path of the one or more additional paths.

In some aspects, process 1500 includes transmitting, to the sensing entity, a capability report of the first sensing node comprising an indication of support for PTIs.

In some aspects, process 1500 includes receiving, from the sensing entity, a request for a capability indication associated with the support for PTIs, wherein the capability report is transmitted responsive to the request.

In some aspects, each of the one or more PTIs is expressed as a hard value or a soft value.

Although FIG. 15 shows example blocks of process 1500, in some implementations, process 1500 may include additional blocks, fewer blocks, different blocks, or differently arranged blocks than those depicted in FIG. 15. Additionally, or alternatively, two or more of the blocks of process 1500 may be performed in parallel.

As will be appreciated, a technical advantage of the process 1500 is that by indicating a PTI, the sensing server can obtain location information of a target to efficiently track the target subsequent to detection in a wireless communications network. That is, for example, one or more PTIs reported by the sensing nodes to the sensing server enables efficient and accurate tracking phases to be performed.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a first sensing node, comprising: obtaining measurements of one or more paths of one or more first sensing reference signals associated with a second sensing node over a first wireless channel; and transmitting, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

Clause 2. The method of clause 1, further comprising: obtaining initial measurements of the one or more paths of the one or more first sensing reference signals during a first time period to obtain a reference state of the first wireless channel; and determining that the first wireless channel is estimated to include reflections from the target based at least in part on a comparison of a measured state and the reference state, wherein: the first CTI indicates that the first wireless channel is estimated to include reflections from the target based at least in part on the determining, and the measured state is based at least in part on the obtaining measurements of one or more paths of one or more first sensing reference signals associated with the second sensing node over the first wireless channel during a second time period different from the first time period.

Clause 3. The method of any of clauses 1 to 2, further comprising: estimating a Doppler profile for each of the one or more paths; and determining that the first wireless channel is estimated to include reflections from the target based at least in part on the estimating the Doppler profile for each of the one or more paths, wherein the first CTI indicates that the first wireless channel is estimated to include reflections from the target based at least in part on the determining.

Clause 4. The method of clause 3, further comprising: determining that the target is estimated to be moving based at least in part on the estimating the Doppler profile for each of the one or more paths, wherein the first measurement report includes information indicating that the target is estimated to be moving.

Clause 5. The method of any of clauses 1 to 4, further comprising: receiving, from the sensing entity, a sensing configuration that includes first information and second information, wherein: the first information indicates that a first reference signal set including the one or more first sensing reference signals is associated with the second sensing node, and the second information indicates that a second reference signal set including one or more second sensing reference signals is associated with a third sensing node different from the second sensing node.

Clause 6. The method of clause 5, further comprising: obtaining measurements of one or more paths of the one or more second sensing reference signals associated with the third sensing node over a second wireless channel different from the first wireless channel, wherein the first measurement report includes a second CTI associated with the second wireless channel.

Clause 7. The method of clause 6, wherein the second CTI indicates that the second wireless channel is estimated to include reflections from the target or another target different from the target, or that the second wireless channel is estimated to include clutter reflections absent target reflections.

Clause 8. The method of any of clauses 1 to 7, further comprising: receiving, from the sensing entity, an indication of a neural network model for estimating the first CTI; obtaining the neural network model based at least in part on the received identification; and receiving assistance data associated with the neural network model.

Clause 9. The method of clause 8, wherein the assistance data associated with the neural network model comprises information corresponding to a reference state of the first wireless channel.

Clause 10. The method of any of clauses 1 to 9, further comprising: obtaining measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target; and transmitting, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

Clause 11. The method of clause 10, wherein the one or more second sensing reference signals are associated with a second frequency range different from a first frequency range of the one or more first sensing reference signals.

Clause 12. The method of any of clauses 1 to 11, further comprising: determining that at least one additional path is associated with the target based at least in part on the measurements of the one or more paths of the one or more first sensing reference signals, wherein the first measurement report includes information indicating the at least one additional path.

Clause 13. The method of clause 12, further comprising: determining a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

Clause 14. The method of any of clauses 1 to 13, wherein the CTI is expressed as a hard value or a soft value.

Clause 15. The method of any of clauses 1 to 14, wherein the first sensing node is a user equipment (UE) or a transmission-reception point (TRP).

Clause 16. The method of any of clauses 1 to 15, wherein the first sensing node is a transmitting sensing node or a receiving sensing node.

Clause 17. The method of any of clauses 1 to 16, wherein the sensing entity is a sensing server or a next generation radio access network (NG-RAN) node.

Clause 18. A method of wireless communication performed by a first sensing node, comprising: receiving, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and performing a sensing session over the wireless channel associated with the target based at least in part on at least one CTI of the one or more CTIs indicating that the wireless channel is estimated to include reflections from a target.

Clause 19. The method of clause 18, further comprising: transmitting, to the sensing entity, a request for the one or more CTIs associated with the wireless channel, wherein the assistance data is received responsive to the request.

Clause 20. The method of any of clauses 18 to 19, wherein the information indicating one or more CTIs associated with the wireless channel comprises an information element corresponding to an expected likelihood of the target in a propagation path of the wireless channel from a transmission-reception point (TRP) to the first sensing node.

Clause 21. The method of any of clauses 18 to 20, further comprising: transmitting, to the sensing entity, a capability report of the first sensing node comprising an indication of support for CTIs, wherein the capability report of the first sensing node comprises an indicated type and granularity supported for the CTIs.

Clause 22. The method of clause 21, further comprising: receiving, from the sensing entity, a request for a capability indication associated with the support for CTIs, wherein the capability report is transmitted responsive to the request.

Clause 23. The method of any of clauses 18 to 22, wherein the first sensing node is a user equipment (UE) and a transmitting sensing node.

Clause 24. A method of wireless communication performed by a first sensing node, comprising: obtaining first measurements of one or more first paths of one or more sensing reference signals associated with a second sensing node over a wireless channel during a first time period; obtaining second measurements of one or more second paths of one or more sensing reference signals associated with a second sensing node over a wireless channel during a second time period different for the first time period; and transmitting, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

Clause 25. The method of clause 24, further comprising: determining one or more additional paths for the wireless channel based at least in part on the obtaining the second measurements, wherein each PTI of the one or more PTIs corresponds to each additional path of the one or more additional paths.

Clause 26. The method of clause 25, wherein: each PTI of the one or more PTIs is indicated in a PTI field of an additional path information element, and the additional path information element includes a first field specifying a reference signal received path power and a second field specifying an angle of arrival for each additional path of the one or more additional paths.

Clause 27. The method of any of clauses 24 to 26, further comprising: transmitting, to the sensing entity, a capability report of the first sensing node comprising an indication of support for PTIs.

Clause 28. The method of clause 27, further comprising: receiving, from the sensing entity, a request for a capability indication associated with the support for PTIs, wherein the capability report is transmitted responsive to the request.

Clause 29. The method of any of clauses 24 to 28, wherein each of the one or more PTIs is expressed as a hard value or a soft value.

Clause 30. A first sensing node, comprising: one or more memories; one or more transceivers; and one or more processors communicatively coupled to the one or more memories and the one or more transceivers, the one or more processors, either alone or in combination, configured to: obtain measurements of one or more paths of one or more first sensing reference signals associated with a second sensing node over a first wireless channel; and transmit, via the one or more transceivers, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

Clause 31. The first sensing node of clause 30, wherein the one or more processors, either alone or in combination, are further configured to: obtain initial measurements of the one or more paths of the one or more first sensing reference signals during a first time period to obtain a reference state of the first wireless channel; and determine that the first wireless channel is estimated to include reflections from the target based at least in part on a comparison of a measured state and the reference state, wherein: the first CTI indicates that the first wireless channel is estimated to include reflections from the target based at least in part on the determining, and the measured state is based at least in part on the obtaining measurements of one or more paths of one or more first sensing reference signals associated with the second sensing node over the first wireless channel during a second time period different from the first time period.

Clause 32. The first sensing node of any of clauses 30 to 31, wherein the one or more processors, either alone or in combination, are further configured to: estimate a Doppler profile for each of the one or more paths; and determine that the first wireless channel is estimated to include reflections from the target based at least in part on the estimating the Doppler profile for each of the one or more paths, wherein the first CTI indicates that the first wireless channel is estimated to include reflections from the target based at least in part on the determining.

Clause 33. The first sensing node of clause 32, wherein the one or more processors, either alone or in combination, are further configured to: determine that the target is estimated to be moving based at least in part on the estimating the Doppler profile for each of the one or more paths, wherein the first measurement report includes information indicating that the target is estimated to be moving.

Clause 34. The first sensing node of any of clauses 30 to 33, wherein the one or more processors, either alone or in combination, are further configured to: receive, via the one or more transceivers, from the sensing entity, a sensing configuration that includes first information and second information, wherein: the first information indicates that a first reference signal set including the one or more first sensing reference signals is associated with the second sensing node, and the second information indicates that a second reference signal set including one or more second sensing reference signals is associated with a third sensing node different from the second sensing node.

Clause 35. The first sensing node of clause 34, wherein the one or more processors, either alone or in combination, are further configured to: obtain measurements of one or more paths of the one or more second sensing reference signals associated with the third sensing node over a second wireless channel different from the first wireless channel, wherein the first measurement report includes a second CTI associated with the second wireless channel.

Clause 36. The first sensing node of clause 35, wherein the second CTI indicates that the second wireless channel is estimated to include reflections from the target or another target different from the target, or that the second wireless channel is estimated to include clutter reflections absent target reflections.

Clause 37. The first sensing node of any of clauses 30 to 36, wherein the one or more processors, either alone or in combination, are further configured to: receive, via the one or more transceivers, from the sensing entity, an indication of a neural network model for estimating the first CTI; obtain the neural network model based at least in part on the received identification; and receive, via the one or more transceivers, assistance data associated with the neural network model.

Clause 38. The first sensing node of clause 37, wherein the assistance data associated with the neural network model comprises information corresponding to a reference state of the first wireless channel.

Clause 39. The first sensing node of any of clauses 30 to 38, wherein the one or more processors, either alone or in combination, are further configured to: obtain measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target; and transmit, via the one or more transceivers, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

Clause 40. The first sensing node of clause 39, wherein the one or more second sensing reference signals are associated with a second frequency range different from a first frequency range of the one or more first sensing reference signals.

Clause 41. The first sensing node of any of clauses 30 to 40, wherein the one or more processors, either alone or in combination, are further configured to: determine that at least one additional path is associated with the target based at least in part on the measurements of the one or more paths of the one or more first sensing reference signals, wherein the first measurement report includes information indicating the at least one additional path.

Clause 42. The first sensing node of clause 41, wherein the one or more processors, either alone or in combination, are further configured to: determine a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

Clause 43. The first sensing node of any of clauses 30 to 42, wherein the CTI is expressed as a hard value or a soft value.

Clause 44. The first sensing node of any of clauses 30 to 43, wherein the first sensing node is a user equipment (UE) or a transmission-reception point (TRP).

Clause 45. The first sensing node of any of clauses 30 to 44, wherein the first sensing node is a transmitting sensing node or a receiving sensing node.

Clause 46. The first sensing node of any of clauses 30 to 45, wherein the sensing entity is a sensing server or a next generation radio access network (NG-RAN) node.

Clause 47. A first sensing node, comprising: one or more memories; one or more transceivers; and one or more processors communicatively coupled to the one or more memories and the one or more transceivers, the one or more processors, either alone or in combination, configured to: receive, via the one or more transceivers, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and perform a sensing session over the wireless channel associated with the target based at least in part on at least one CTI of the one or more CTIs indicating that the wireless channel is estimated to include reflections from a target.

Clause 48. The first sensing node of clause 47, wherein the one or more processors, either alone or in combination, are further configured to: transmit, via the one or more transceivers, to the sensing entity, a request for the one or more CTIs associated with the wireless channel, wherein the assistance data is received responsive to the request.

Clause 49. The first sensing node of any of clauses 47 to 48, wherein the information indicating one or more CTIs associated with the wireless channel comprises an information element corresponding to an expected likelihood of the target in a propagation path of the wireless channel from a transmission-reception point (TRP) to the first sensing node.

Clause 50. The first sensing node of any of clauses 47 to 49, wherein the one or more processors, either alone or in combination, are further configured to: transmit, via the one or more transceivers, to the sensing entity, a capability report of the first sensing node comprising an indication of support for CTIs, wherein the capability report of the first sensing node comprises an indicated type and granularity supported for the CTIs.

Clause 51. The first sensing node of clause 50, wherein the one or more processors, either alone or in combination, are further configured to: receive, via the one or more transceivers, from the sensing entity, a request for a capability indication associated with the support for CTIs, wherein the capability report is transmitted responsive to the request.

Clause 52. The first sensing node of any of clauses 47 to 51, wherein the first sensing node is a user equipment (UE) and a transmitting sensing node.

Clause 53. A first sensing node, comprising: one or more memories; one or more transceivers; and one or more processors communicatively coupled to the one or more memories and the one or more transceivers, the one or more processors, either alone or in combination, configured to: obtain first measurements of one or more first paths of one or more sensing reference signals associated with a second sensing node over a wireless channel during a first time period; obtain second measurements of one or more second paths of one or more sensing reference signals associated with a second sensing node over a wireless channel during a second time period different for the first time period; and transmit, via the one or more transceivers, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

Clause 54. The first sensing node of clause 53, wherein the one or more processors, either alone or in combination, are further configured to: determine one or more additional paths for the wireless channel based at least in part on the obtaining the second measurements, wherein each PTI of the one or more PTIs corresponds to each additional path of the one or more additional paths.

Clause 55. The first sensing node of clause 54, wherein: each PTI of the one or more PTIs is indicated in a PTI field of an additional path information element, and the additional path information element includes a first field specifying a reference signal received path power and a second field specifying an angle of arrival for each additional path of the one or more additional paths.

Clause 56. The first sensing node of any of clauses 53 to 55, wherein the one or more processors, either alone or in combination, are further configured to: transmit, via the one or more transceivers, to the sensing entity, a capability report of the first sensing node comprising an indication of support for PTIs.

Clause 57. The first sensing node of clause 56, wherein the one or more processors, either alone or in combination, are further configured to: receive, via the one or more transceivers, from the sensing entity, a request for a capability indication associated with the support for PTIs, wherein the capability report is transmitted responsive to the request.

Clause 58. The first sensing node of any of clauses 53 to 57, wherein each of the one or more PTIs is expressed as a hard value or a soft value.

Clause 59. A first sensing node, comprising: means for obtaining measurements of one or more paths of one or more first sensing reference signals associated with a second sensing node over a first wireless channel; and means for transmitting, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

Clause 60. The first sensing node of clause 59, further comprising: means for obtaining initial measurements of the one or more paths of the one or more first sensing reference signals during a first time period to obtain a reference state of the first wireless channel; and means for determining that the first wireless channel is estimated to include reflections from the target based at least in part on a comparison of a measured state and the reference state, wherein: the first CTI indicates that the first wireless channel is estimated to include reflections from the target based at least in part on the determining, and the measured state is based at least in part on the obtaining measurements of one or more paths of one or more first sensing reference signals associated with the second sensing node over the first wireless channel during a second time period different from the first time period.

Clause 61. The first sensing node of any of clauses 59 to 60, further comprising: means for estimating a Doppler profile for each of the one or more paths; and means for determining that the first wireless channel is estimated to include reflections from the target based at least in part on the estimating the Doppler profile for each of the one or more paths, wherein the first CTI indicates that the first wireless channel is estimated to include reflections from the target based at least in part on the determining.

Clause 62. The first sensing node of clause 61, further comprising: means for determining that the target is estimated to be moving based at least in part on the estimating the Doppler profile for each of the one or more paths, wherein the first measurement report includes information indicating that the target is estimated to be moving.

Clause 63. The first sensing node of any of clauses 59 to 62, further comprising: means for receiving, from the sensing entity, a sensing configuration that includes first information and second information, wherein: the first information indicates that a first reference signal set including the one or more first sensing reference signals is associated with the second sensing node, and the second information indicates that a second reference signal set including one or more second sensing reference signals is associated with a third sensing node different from the second sensing node.

Clause 64. The first sensing node of clause 63, further comprising: means for obtaining measurements of one or more paths of the one or more second sensing reference signals associated with the third sensing node over a second wireless channel different from the first wireless channel, wherein the first measurement report includes a second CTI associated with the second wireless channel.

Clause 65. The first sensing node of clause 64, wherein the second CTI indicates that the second wireless channel is estimated to include reflections from the target or another target different from the target, or that the second wireless channel is estimated to include clutter reflections absent target reflections.

Clause 66. The first sensing node of any of clauses 59 to 65, further comprising: means for receiving, from the sensing entity, an indication of a neural network model for estimating the first CTI; means for obtaining the neural network model based at least in part on the received identification; and means for receiving assistance data associated with the neural network model.

Clause 67. The first sensing node of clause 66, wherein the assistance data associated with the neural network model comprises information corresponding to a reference state of the first wireless channel.

Clause 68. The first sensing node of any of clauses 59 to 67, further comprising: means for obtaining measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target; and means for transmitting, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

Clause 69. The first sensing node of clause 68, wherein the one or more second sensing reference signals are associated with a second frequency range different from a first frequency range of the one or more first sensing reference signals.

Clause 70. The first sensing node of any of clauses 59 to 69, further comprising: means for determining that at least one additional path is associated with the target based at least in part on the measurements of the one or more paths of the one or more first sensing reference signals, wherein the first measurement report includes information indicating the at least one additional path.

Clause 71. The first sensing node of clause 70, further comprising: means for determining a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

Clause 72. The first sensing node of any of clauses 59 to 71, wherein the CTI is expressed as a hard value or a soft value.

Clause 73. The first sensing node of any of clauses 59 to 72, wherein the first sensing node is a user equipment (UE) or a transmission-reception point (TRP).

Clause 74. The first sensing node of any of clauses 59 to 73, wherein the first sensing node is a transmitting sensing node or a receiving sensing node.

Clause 75. The first sensing node of any of clauses 59 to 74, wherein the sensing entity is a sensing server or a next generation radio access network (NG-RAN) node.

Clause 76. A first sensing node, comprising: means for receiving, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and means for performing a sensing session over the wireless channel associated with the target based at least in part on at least one CTI of the one or more CTIs indicating that the wireless channel is estimated to include reflections from a target.

Clause 77. The first sensing node of clause 76, further comprising: means for transmitting, to the sensing entity, a request for the one or more CTIs associated with the wireless channel, wherein the assistance data is received responsive to the request.

Clause 78. The first sensing node of any of clauses 76 to 77, wherein the information indicating one or more CTIs associated with the wireless channel comprises an information element corresponding to an expected likelihood of the target in a propagation path of the wireless channel from a transmission-reception point (TRP) to the first sensing node.

Clause 79. The first sensing node of any of clauses 76 to 78, further comprising: means for transmitting, to the sensing entity, a capability report of the first sensing node comprising an indication of support for CTIs, wherein the capability report of the first sensing node comprises an indicated type and granularity supported for the CTIs.

Clause 80. The first sensing node of clause 79, further comprising: means for receiving, from the sensing entity, a request for a capability indication associated with the support for CTIs, wherein the capability report is transmitted responsive to the request.

Clause 81. The first sensing node of any of clauses 76 to 80, wherein the first sensing node is a user equipment (UE) and a transmitting sensing node.

Clause 82. A first sensing node, comprising: means for obtaining first measurements of one or more first paths of one or more sensing reference signals associated with a second sensing node over a wireless channel during a first time period; means for obtaining second measurements of one or more second paths of one or more sensing reference signals associated with a second sensing node over a wireless channel during a second time period different for the first time period; and means for transmitting, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

Clause 83. The first sensing node of clause 82, further comprising: means for determining one or more additional paths for the wireless channel based at least in part on the obtaining the second measurements, wherein each PTI of the one or more PTIs corresponds to each additional path of the one or more additional paths.

Clause 84. The first sensing node of clause 83, wherein: each PTI of the one or more PTIs is indicated in a PTI field of an additional path information element, and the additional path information element includes a first field specifying a reference signal received path power and a second field specifying an angle of arrival for each additional path of the one or more additional paths.

Clause 85. The first sensing node of any of clauses 82 to 84, further comprising: means for transmitting, to the sensing entity, a capability report of the first sensing node comprising an indication of support for PTIs.

Clause 86. The first sensing node of clause 85, further comprising: means for receiving, from the sensing entity, a request for a capability indication associated with the support for PTIs, wherein the capability report is transmitted responsive to the request.

Clause 87. The first sensing node of any of clauses 82 to 86, wherein each of the one or more PTIs is expressed as a hard value or a soft value.

Clause 88. A non-transitory computer-readable medium storing computer-executable instructions that, when executed by a first sensing node, cause the first sensing node to: obtain measurements of one or more paths of one or more first sensing reference signals associated with a second sensing node over a first wireless channel; and transmit, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

Clause 89. The non-transitory computer-readable medium of clause 88, further comprising computer-executable instructions that, when executed by the first sensing node, cause the first sensing node to: obtain initial measurements of the one or more paths of the one or more first sensing reference signals during a first time period to obtain a reference state of the first wireless channel; and determine that the first wireless channel is estimated to include reflections from the target based at least in part on a comparison of a measured state and the reference state, wherein: the first CTI indicates that the first wireless channel is estimated to include reflections from the target based at least in part on the determining, and the measured state is based at least in part on the obtaining measurements of one or more paths of one or more first sensing reference signals associated with the second sensing node over the first wireless channel during a second time period different from the first time period.

Clause 90. The non-transitory computer-readable medium of any of clauses 88 to 89, further comprising computer-executable instructions that, when executed by the first sensing node, cause the first sensing node to: estimate a Doppler profile for each of the one or more paths; and determine that the first wireless channel is estimated to include reflections from the target based at least in part on the estimating the Doppler profile for each of the one or more paths, wherein the first CTI indicates that the first wireless channel is estimated to include reflections from the target based at least in part on the determining.

Clause 91. The non-transitory computer-readable medium of clause 90, further comprising computer-executable instructions that, when executed by the first sensing node, cause the first sensing node to: determine that the target is estimated to be moving based at least in part on the estimating the Doppler profile for each of the one or more paths, wherein the first measurement report includes information indicating that the target is estimated to be moving.

Clause 92. The non-transitory computer-readable medium of any of clauses 88 to 91, further comprising computer-executable instructions that, when executed by the first sensing node, cause the first sensing node to: receive, from the sensing entity, a sensing configuration that includes first information and second information, wherein: the first information indicates that a first reference signal set including the one or more first sensing reference signals is associated with the second sensing node, and the second information indicates that a second reference signal set including one or more second sensing reference signals is associated with a third sensing node different from the second sensing node.

Clause 93. The non-transitory computer-readable medium of clause 92, further comprising computer-executable instructions that, when executed by the first sensing node, cause the first sensing node to: obtain measurements of one or more paths of the one or more second sensing reference signals associated with the third sensing node over a second wireless channel different from the first wireless channel, wherein the first measurement report includes a second CTI associated with the second wireless channel.

Clause 94. The non-transitory computer-readable medium of clause 93, wherein the second CTI indicates that the second wireless channel is estimated to include reflections from the target or another target different from the target, or that the second wireless channel is estimated to include clutter reflections absent target reflections.

Clause 95. The non-transitory computer-readable medium of any of clauses 88 to 94, further comprising computer-executable instructions that, when executed by the first sensing node, cause the first sensing node to: receive, from the sensing entity, an indication of a neural network model for estimating the first CTI; obtain the neural network model based at least in part on the received identification; and receive assistance data associated with the neural network model.

Clause 96. The non-transitory computer-readable medium of clause 95, wherein the assistance data associated with the neural network model comprises information corresponding to a reference state of the first wireless channel.

Clause 97. The non-transitory computer-readable medium of any of clauses 88 to 96, further comprising computer-executable instructions that, when executed by the first sensing node, cause the first sensing node to: obtain measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target; and transmit, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

Clause 98. The non-transitory computer-readable medium of clause 97, wherein the one or more second sensing reference signals are associated with a second frequency range different from a first frequency range of the one or more first sensing reference signals.

Clause 99. The non-transitory computer-readable medium of any of clauses 88 to 98, further comprising computer-executable instructions that, when executed by the first sensing node, cause the first sensing node to: determine that at least one additional path is associated with the target based at least in part on the measurements of the one or more paths of the one or more first sensing reference signals, wherein the first measurement report includes information indicating the at least one additional path.

Clause 100. The non-transitory computer-readable medium of clause 99, further comprising computer-executable instructions that, when executed by the first sensing node, cause the first sensing node to: determine a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

Clause 101. The non-transitory computer-readable medium of any of clauses 88 to 100, wherein the CTI is expressed as a hard value or a soft value.

Clause 102. The non-transitory computer-readable medium of any of clauses 88 to 101, wherein the first sensing node is a user equipment (UE) or a transmission-reception point (TRP).

Clause 103. The non-transitory computer-readable medium of any of clauses 88 to 102, wherein the first sensing node is a transmitting sensing node or a receiving sensing node.

Clause 104. The non-transitory computer-readable medium of any of clauses 88 to 103, wherein the sensing entity is a sensing server or a next generation radio access network (NG-RAN) node.

Clause 105. A non-transitory computer-readable medium storing computer-executable instructions that, when executed by a first sensing node, cause the first sensing node to: receive, from a sensing entity, assistance data comprising information indicating one or more channel target indicators (CTIs) associated with a wireless channel, wherein the one or more CTIs indicate that the wireless channel is estimated to include reflections from a target, or that the wireless channel is estimated to include clutter reflections absent target reflections, or both; and perform a sensing session over the wireless channel associated with the target based at least in part on at least one CTI of the one or more CTIs indicating that the wireless channel is estimated to include reflections from a target.

Clause 106. The non-transitory computer-readable medium of clause 105, further comprising computer-executable instructions that, when executed by the first sensing node, cause the first sensing node to: transmit, to the sensing entity, a request for the one or more CTIs associated with the wireless channel, wherein the assistance data is received responsive to the request.

Clause 107. The non-transitory computer-readable medium of any of clauses 105 to 106, wherein the information indicating one or more CTIs associated with the wireless channel comprises an information element corresponding to an expected likelihood of the target in a propagation path of the wireless channel from a transmission-reception point (TRP) to the first sensing node.

Clause 108. The non-transitory computer-readable medium of any of clauses 105 to 107, further comprising computer-executable instructions that, when executed by the first sensing node, cause the first sensing node to: transmit, to the sensing entity, a capability report of the first sensing node comprising an indication of support for CTIs, wherein the capability report of the first sensing node comprises an indicated type and granularity supported for the CTIs.

Clause 109. The non-transitory computer-readable medium of clause 108, further comprising computer-executable instructions that, when executed by the first sensing node, cause the first sensing node to: receive, from the sensing entity, a request for a capability indication associated with the support for CTIs, wherein the capability report is transmitted responsive to the request.

Clause 110. The non-transitory computer-readable medium of any of clauses 105 to 109, wherein the first sensing node is a user equipment (UE) and a transmitting sensing node.

Clause 111. A non-transitory computer-readable medium storing computer-executable instructions that, when executed by a first sensing node, cause the first sensing node to: obtain first measurements of one or more first paths of one or more sensing reference signals associated with a second sensing node over a wireless channel during a first time period; obtain second measurements of one or more second paths of one or more sensing reference signals associated with a second sensing node over a wireless channel during a second time period different for the first time period; and transmit, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

Clause 112. The non-transitory computer-readable medium of clause 111, further comprising computer-executable instructions that, when executed by the first sensing node, cause the first sensing node to: determine one or more additional paths for the wireless channel based at least in part on the obtaining the second measurements, wherein each PTI of the one or more PTIs corresponds to each additional path of the one or more additional paths.

Clause 113. The non-transitory computer-readable medium of clause 112, wherein: each PTI of the one or more PTIs is indicated in a PTI field of an additional path information element, and the additional path information element includes a first field specifying a reference signal received path power and a second field specifying an angle of arrival for each additional path of the one or more additional paths.

Clause 114. The non-transitory computer-readable medium of any of clauses 111 to 113, further comprising computer-executable instructions that, when executed by the first sensing node, cause the first sensing node to: transmit, to the sensing entity, a capability report of the first sensing node comprising an indication of support for PTIs.

Clause 115. The non-transitory computer-readable medium of clause 114, further comprising computer-executable instructions that, when executed by the first sensing node, cause the first sensing node to: receive, from the sensing entity, a request for a capability indication associated with the support for PTIs, wherein the capability report is transmitted responsive to the request.

Clause 116. The non-transitory computer-readable medium of any of clauses 111 to 115, wherein each of the one or more PTIs is expressed as a hard value or a soft value.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programmable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. For example, the functions, steps and/or actions of the method claims in accordance with the aspects of the disclosure described herein need not be performed in any particular order. Further, no component, function, action, or instruction described or claimed herein should be construed as critical or essential unless explicitly described as such. Furthermore, as used herein, the terms “set,” “group,” and the like are intended to include one or more of the stated elements. Also, as used herein, the terms “has,” “have,” “having,” “comprises,” “comprising,” “includes,” “including,” and the like does not preclude the presence of one or more additional elements (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”) or the alternatives are mutually exclusive (e.g., “one or more” should not be interpreted as “one and more”). Furthermore, although components, functions, actions, and instructions may be described or claimed in the singular, the plural is contemplated unless limitation to the singular is explicitly stated. Accordingly, as used herein, the articles “a,” “an,” “the,” and “said” are intended to include one or more of the stated elements. Additionally, as used herein, the terms “at least one” and “one or more” encompass “one” component, function, action, or instruction performing or capable of performing a described or claimed functionality and also “two or more” components, functions, actions, or instructions performing or capable of performing a described or claimed functionality in combination.

What is claimed is:

1. A first sensing node, comprising:
one or more memories;
one or more transceivers; and
one or more processors communicatively coupled to the one or more memories and the one or more transceivers, the one or more processors, either alone or in combination, configured to:
obtain measurements of one or more paths of one or more first sensing reference signals associated with a second sensing node over a first wireless channel; and
transmit, via the one or more transceivers, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

2. The first sensing node of claim 1, wherein the one or more processors, either alone or in combination, are further configured to:
obtain initial measurements of the one or more paths of the one or more first sensing reference signals during a first time period to obtain a reference state of the first wireless channel; and
determine that the first wireless channel is estimated to include reflections from the target based at least in part on a comparison of a measured state and the reference state, wherein:
the first CTI indicates that the first wireless channel is estimated to include reflections from the target based at least in part on the determining, and
the measured state is based at least in part on the obtaining measurements of one or more paths of one or more first sensing reference signals associated with the second sensing node over the first wireless channel during a second time period different from the first time period.

3. The first sensing node of claim 1, wherein the one or more processors, either alone or in combination, are further configured to:
estimate a Doppler profile for each of the one or more paths; and
determine that the first wireless channel is estimated to include reflections from the target based at least in part on the estimating the Doppler profile for each of the one or more paths, wherein the first CTI indicates that the first wireless channel is estimated to include reflections from the target based at least in part on the determining.

4. The first sensing node of claim 3, wherein the one or more processors, either alone or in combination, are further configured to:
determine that the target is estimated to be moving based at least in part on the estimating the Doppler profile for each of the one or more paths, wherein the first measurement report includes information indicating that the target is estimated to be moving.

5. The first sensing node of claim 1, wherein the one or more processors, either alone or in combination, are further configured to:
receive, via the one or more transceivers, from the sensing entity, a sensing configuration that includes first information and second information, wherein:
the first information indicates that a first reference signal set including the one or more first sensing reference signals is associated with the second sensing node, and
the second information indicates that a second reference signal set including one or more second sensing reference signals is associated with a third sensing node different from the second sensing node.

6. The first sensing node of claim 5, wherein the one or more processors, either alone or in combination, are further configured to:
obtain measurements of one or more paths of the one or more second sensing reference signals associated with the third sensing node over a second wireless channel different from the first wireless channel, wherein the first measurement report includes a second CTI associated with the second wireless channel.

7. The first sensing node of claim 6, wherein the second CTI indicates that the second wireless channel is estimated to include reflections from the target or another target different from the target, or that the second wireless channel is estimated to include clutter reflections absent target reflections.

8. The first sensing node of claim 1, wherein the one or more processors, either alone or in combination, are further configured to:
receive, via the one or more transceivers, from the sensing entity, an indication of a neural network model for estimating the first CTI;
obtain the neural network model based at least in part on the received identification; and
receive, via the one or more transceivers, assistance data associated with the neural network model.

9. The first sensing node of claim 8, wherein the assistance data associated with the neural network model comprises information corresponding to a reference state of the first wireless channel.

10. The first sensing node of claim 1, wherein the one or more processors, either alone or in combination, are further configured to:
obtain measurements of one or more paths of one or more second sensing reference signals associated with the second sensing node over the first wireless channel, wherein the obtaining of the one or more paths of the one or more second sensing reference signals associated with the second sensing node is based at least in part on the first CTI indicating that the first wireless channel is estimated to include reflections from the target; and
transmit, via the one or more transceivers, to the sensing entity, a second measurement report including a second CTI associated with one or more sensing signals and the first wireless channel, wherein the second CTI indicates that the first wireless channel is estimated to include reflections from the target or that the first wireless channel is estimated to include clutter reflections absent target reflections.

11. The first sensing node of claim 10, wherein the one or more second sensing reference signals are associated with a second frequency range different from a first frequency range of the one or more first sensing reference signals.

12. The first sensing node of claim 1, wherein the one or more processors, either alone or in combination, are further configured to:
determine that at least one additional path is associated with the target based at least in part on the measurements of the one or more paths of the one or more first sensing reference signals, wherein the first measurement report includes information indicating the at least one additional path.

13. The first sensing node of claim 12, wherein the one or more processors, either alone or in combination, are further configured to:
determine a reflection order corresponding to the at least one additional path associated with the target based at least in part on propagation information associated with the measurements of the one or more paths of the one or more first sensing reference signals, wherein the first measurement report includes information indicating the reflection order corresponding to the at least one additional path associated with the target.

14. The first sensing node of claim 1, wherein the CTI is expressed as a hard value or a soft value.

15. The first sensing node of claim 1, wherein the first sensing node is a user equipment (UE) or a transmission-reception point (TRP).

16. The first sensing node of claim 1, wherein the first sensing node is a transmitting sensing node or a receiving sensing node.

17. The first sensing node of claim 1, wherein the sensing entity is a sensing server or a next generation radio access network (NG-RAN) node.

18. A first sensing node, comprising:
one or more memories;
one or more transceivers; and
one or more processors communicatively coupled to the one or more memories and the one or more transceivers, the one or more processors, either alone or in combination, configured to:
obtain first measurements of one or more first paths of one or more sensing reference signals associated with a second sensing node over a wireless channel during a first time period;
obtain second measurements of one or more second paths of one or more sensing reference signals associated with a second sensing node over a wireless channel during a second time period different for the first time period; and
transmit, via the one or more transceivers, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

19. The first sensing node of claim 18, wherein the one or more processors, either alone or in combination, are further configured to:
determine one or more additional paths for the wireless channel based at least in part on the obtaining the second measurements, wherein each PTI of the one or more PTIs corresponds to each additional path of the one or more additional paths.

20. The first sensing node of claim 19, wherein:
each PTI of the one or more PTIs is indicated in a PTI field of an additional path information element, and
the additional path information element includes a first field specifying a reference signal received path power and a second field specifying an angle of arrival for each additional path of the one or more additional paths.

21. The first sensing node of claim 18, wherein the one or more processors, either alone or in combination, are further configured to:
transmit, via the one or more transceivers, to the sensing entity, a capability report of the first sensing node comprising an indication of support for PTIs.

22. The first sensing node of claim 21, wherein the one or more processors, either alone or in combination, are further configured to:
receive, via the one or more transceivers, from the sensing entity, a request for a capability indication associated with the support for PTIs, wherein the capability report is transmitted responsive to the request.

23. The first sensing node of claim 18, wherein each of the one or more PTIs is expressed as a hard value or a soft value.

24. A method of wireless communication performed by a first sensing node, comprising:
obtaining measurements of one or more paths of one or more first sensing reference signals associated with a second sensing node over a first wireless channel; and
transmitting, to a sensing entity, a first measurement report including a first channel target indicator (CTI) associated with the first wireless channel, wherein the first CTI indicates that the first wireless channel is estimated to include reflections from a target or that the first wireless channel is estimated to include clutter reflections absent target reflections.

25. The method of claim 24, further comprising:
obtaining initial measurements of the one or more paths of the one or more first sensing reference signals during a first time period to obtain a reference state of the first wireless channel; and
determining that the first wireless channel is estimated to include reflections from the target based at least in part on a comparison of a measured state and the reference state, wherein:
the first CTI indicates that the first wireless channel is estimated to include reflections from the target based at least in part on the determining, and
the measured state is based at least in part on the obtaining measurements of one or more paths of one or more first sensing reference signals associated with the second sensing node over the first wireless channel during a second time period different from the first time period.

26. The method of claim 24, further comprising:
estimating a Doppler profile for each of the one or more paths; and
determining that the first wireless channel is estimated to include reflections from the target based at least in part on the estimating the Doppler profile for each of the one or more paths, wherein the first CTI indicates that the first wireless channel is estimated to include reflections from the target based at least in part on the determining.

27. The method of claim 26, further comprising:
determining that the target is estimated to be moving based at least in part on the estimating the Doppler profile for each of the one or more paths, wherein the first measurement report includes information indicating that the target is estimated to be moving.

28. A method of wireless communication performed by a first sensing node, comprising:
obtaining first measurements of one or more first paths of one or more sensing reference signals associated with a second sensing node over a wireless channel during a first time period;
obtaining second measurements of one or more second paths of one or more sensing reference signals associated with a second sensing node over a wireless channel during a second time period different for the first time period; and
transmitting, to a sensing entity, a measurement report including one or more path target indicators (PTIs) associated with one or more second paths of the wireless channel, wherein each PTI of the one or more PTIs indicates that a corresponding second path of the one or more second paths is estimated to include reflections from a target or that the corresponding second path is estimated to include clutter reflections absent target reflections.

29. The method of claim 28, further comprising:
determining one or more additional paths for the wireless channel based at least in part on the obtaining the second measurements, wherein each PTI of the one or more PTIs corresponds to each additional path of the one or more additional paths.

30. The method of claim 29, wherein:
each PTI of the one or more PTIs is indicated in a PTI field of an additional path information element, and
the additional path information element includes a first field specifying a reference signal received path power and a second field specifying an angle of arrival for each additional path of the one or more additional paths.
